(19) United States
(12) Patent Application Publication
(10) Pub. No.: US 2023/0419763 A1
(43) Pub. Date: Dec. 28, 2023

(54) AUTOMATED MONEY ITEM HANDLING SYSTEM AND METHOD OF OPERATION

(71) Applicant: Crane Payment Innovations Limited, Royton, Oldham (GB)

(72) Inventors: Kevin MULVEY, Warrington (GB); Ian PEERS, Oldham (GB); David TAYLOR, Bolton (GB)

(21) Appl. No.: 18/252,028

(22) PCT Filed: Nov. 4, 2021
(86) PCT No.: PCT/GB2021/052860

§ 371 Date: May 5, 2023

(30) Foreign Application Priority Data
Nov. 6, 2020 (GB) 2017594.9

(51) Int. Cl. G07D 9/00

(52) U.S. Cl. CPC G07D 9/008; G07D 2201/00

(57) ABSTRACT

An example method of operating a supply apparatus of the money item handling system comprises storing, in a plurality of separate money item reservoirs of the apparatus, a plurality of sets of money items, wherein each set of money items is stored in a different one of the plurality of separate money reservoirs and comprises money items of different denominations; selecting, from the plurality of separate money item reservoirs and sets of stored money items, a money item reservoir and a set of stored money items; switching a configuration of the selected money item reservoir from a money item retention configuration to a money item supply configuration; and supplying, from the selected money item reservoir in the money item supply configuration, the selected set of money items.

### CROSS-REFERENCE TO RELATED APPLICATIONS

This application is a 371 National Stage of International Application No. PCT/GB2021/052860, filed Nov. 4, 2021, which claims priority to United Kingdom Patent Application No. 2017594.9, filed Nov. 6, 2020, the disclosures of which are herein incorporated by reference in their entirety.

### TECHNICAL FIELD

This specification relates to an automated money item handling system and method of operating the system. Particularly, but not exclusively, the specification relates to a money item supply apparatus and a method of operating the money item supply apparatus. The specification also relates to a money item gate apparatus and method of operating the gate apparatus.

### BACKGROUND

Money item handling systems can be used to receive, process, store and dispense money items. For example, money items received from users may be processed and stored in the system. Money items may also be dispensed from the system in order to meet a demand.

### SUMMARY

This specification provides a money item supply apparatus, comprising a plurality of separate money item reservoirs configured to store a plurality of sets of money items of mixed denomination, wherein each of the plurality of money item reservoirs is configured to store a different one of the plurality of sets of money items; wherein each of the plurality of money item reservoirs is selectively switchable between a plurality of operating configurations comprising at least a money item retention configuration and a money item supply configuration.

For each of the plurality of money item reservoirs, switching to the money item supply configuration from another of the plurality of operating configurations may comprise aligning a money item outlet of the money item reservoir with a money item output routing.

For each of the plurality of money item reservoirs, switching from the money item supply configuration to another of the plurality of operating configurations may comprise unaligning the money item outlet of the money item reservoir with the money item output routing.

The plurality of operating configurations may further comprise at least a money item receiving configuration.

For each of the plurality of money item reservoirs, switching to the money item receiving configuration from another of the plurality of operating configurations may comprise aligning a money item inlet of the money item reservoir with a money item input routing.

For each of the plurality of money item reservoirs, switching from the money item receiving configuration to another of the plurality of operating configurations may comprise unaligning the money item inlet of the money item reservoir with the money item input routing.

The money item receiving configuration may be a sub configuration of the money item retention configuration.

The money item supply apparatus may comprise a rotatable apparatus and the plurality of money item reservoirs may be located in the rotatable apparatus.

The plurality of money item reservoirs may be separated from one another by at least one internal dividing wall of the rotatable apparatus.

The money item outlet and money item inlet of at least one of the plurality of money item reservoirs may be provided as a shared outlet and inlet aperture in at least one boundary wall of the rotatable apparatus.

The money item outlet and money item inlet of at least one of the plurality of money item reservoirs may be provided as separate outlet and inlet apertures in at least one boundary wall of the rotatable apparatus.

The money item inlets of the plurality of money item reservoirs may be located adjacent to one another in an inlet region of the rotatable apparatus.

The money item inlets of the plurality of money item reservoirs may be located in a row which is uninterrupted by money item outlets.

The money item inlet of at least one of the money item reservoirs may be located on an opposite side of the rotatable apparatus to the at least one of the money item reservoirs.

The money item inlet of the at least one money item reservoir may comprise a channel which extends through a central region of the rotatable apparatus to the at least one money item reservoir.

The rotatable apparatus may be configured to rotate on an axis and, for each of the plurality of money item reservoirs, switching from any particular one of the plurality of operating configurations to any particular other one of the plurality of operating configurations may comprise the rotatable apparatus rotating from a first position to a second position.

For each of the plurality of money item reservoirs, each of the plurality of operating configurations may correspond to a different rotational position of the rotatable apparatus.

Each of the plurality of operating configurations of each of the plurality of money item reservoirs may correspond to a different rotational position of the rotatable apparatus.

The money item supply apparatus may further comprise an actuator configured to selectively rotate the rotatable apparatus between different rotational positions.

The money item input routing may be located at a first position relative to the rotatable apparatus and the money item output routing may be located a second, different position relative to the rotatable apparatus.

The money item input routing may be configured to feed money items towards the rotatable apparatus from a first direction and the money item output routing may be configured to receive money items from the rotatable apparatus from a second direction.

The money item inlet routing may be located towards the top of the rotatable apparatus and the money item outlet routing may be located towards the bottom of the rotatable apparatus.

The money item supply apparatus may comprise a fixed perimeter wall around the rotatable apparatus and the rotatable apparatus may be configured to rotate within the fixed perimeter wall.

The money item output routing may be aligned with a first aperture in the fixed perimeter wall and the money item input routing may be aligned with a second aperture in the fixed perimeter wall.

This specification also provides a money item handling apparatus comprising the money item supply apparatus.

The money item handling apparatus may comprise at least one money item conveyor configured to convey money items from a mixed denomination money item storage region to a money item exit region of the conveyor.

At least one money item gate in the money item exit region may be operable to selectively route money items off the money item conveyor and into the money item input routing.

The money item output may be arranged to selectively route money items output from the money item supply apparatus to another region of the money item handling system.

The other region of the money item handling system may be a money item collection region at an exterior of the money item handling system.

This specification also provides a method of operating a money item supply apparatus, comprising: storing, in a plurality of separate money item reservoirs of the apparatus, a plurality of sets of money items, wherein each set of money items is stored in a different one of the plurality of separate money reservoirs and comprises money items of mixed denominations; selecting, from the plurality of separate money item reservoirs and sets of stored money items, a money item reservoir and a set of stored money items; switching an operating configuration of the selected money item reservoir from a first operating configuration to a second operating configuration, wherein the second operating configuration is a money item supply configuration; and supplying, from the selected money item reservoir in the money item supply configuration, the selected set of money items.

The method may comprise, in response to a demand for money items, selecting at least one individual money item from the supplied set of money items and dispensing the at least one selected money item to a region of a money item handling system.

The method may comprise: in response to determining that the supplied set of money items are insufficient to meet the demand: selecting, from the remaining plurality of separate money item reservoirs and sets of stored money items, a further money item reservoir and a further set of stored money items; switching a configuration of the selected further money item reservoir from a first operating configuration to a second operating configuration, wherein the second operating configuration is a money item supply configuration; and supplying, from the selected further money item reservoir in the money item supply configuration, the selected further set of money items.

The method may comprise, in response to the demand for money items, selecting at least one further individual money item from the supplied further set of money items and dispensing the at least one selected further money item to the region of the money item handling system.

Supplying the selected set of money items may comprise supplying the selected set of money items to a money item conveyor; and dispensing the at least one selected money item may comprise dispensing the at least one selected money item from an exit region of the money item conveyor.

Supplying the selected further set of money items may comprise supplying the selected further set of money items to the money item conveyor; and dispensing the at least one selected further money item may comprise dispensing the at least one selected further money item from the exit region of the money item conveyor.

The method may comprise: determining whether a threshold condition for replenishing the selected money item reservoir with a replacement set of money items comprising said mixed denominations has been met; and where it is determined that the threshold condition has been met, initiating replenishment of the selected money item reservoir with a replacement set of money items comprising said mixed denominations; or where it is determined that the threshold condition has not been met, not initiating replenishment of the selected money item reservoir.

The method may comprise initiating replenishment of the selected money item reservoir with a replacement set of money items comprising said mixed denominations by: identifying replacement money items corresponding to money item denominations in the replacement set; switching a configuration of the selected money item reservoir to a money item receiving configuration; and selectively routing the identified replacement money items into the selected money item reservoir while the selected money item reservoir is in the money item receiving configuration.

The method may further comprise, in response to a further demand for money items: selecting, from the plurality of separate money item reservoirs, a still further money item reservoir and a still further set of stored money items in the selected still further reservoir; switching a configuration of the selected still further money item reservoir from a first operating configuration to a second operating configuration, wherein the second operating configuration is a money item supply configuration; and supplying, from the selected still further money item reservoir in the money item supply configuration, the selected still further set of money items.

The method may comprise, in response to the further demand for money items, selecting at least one still further individual money item from the supplied still further set of money items and dispensing the at least one selected still further money item to the region of the money item handling system.

Supplying the selected still further set of money items may comprise supplying the selected still further set of money items to the money item conveyor; and dispensing the at least one selected still further money item may comprise dispensing the at least one selected still further money item from the exit region of the money item conveyor.

The method may comprise: determining whether a threshold condition for replenishing the selected still further money item reservoir with a set of replacement money items comprising said mixed denominations has been met; and where it is determined that the threshold condition has been met, initiating replenishment of the selected still further money item reservoir with a replacement set of money items comprising said mixed denominations; or where it is determined that the threshold condition has not been met, not initiating replenishment of the selected further money item reservoir.

The method may comprise initiating replenishment of the selected still further money item reservoir with a replacement set of money items comprising said mixed denominations by: identifying replacement money items corresponding to the money item denominations in the replacement set; switching a configuration of the selected still further money item reservoir to a money item receiving configuration; and selectively routing the identified replacement money items into the selected still further money item reservoir while the selected still further money item reservoir is in the money item receiving configuration.

The money item supply apparatus may be arranged to receive money items routed from a money item conveyor to the money item supply apparatus via an input routing.

The conveyor may comprise: a money item sensing region which is configured to at least denominate individual money items on the conveyor; and a money item exit region comprising at least one money item gate through which individual money items are selectively routed off the conveyor into the input routing.

The method may comprise assembling a magazine of a plurality of money items of predetermined denominations on a region of the conveyor between the money item receiving region and the money item exit region.

This specification also provides a method of operating a money item supply apparatus, comprising: determining to fill at least two of a plurality of separate money item reservoirs of the money item supply apparatus with sets of money items, wherein each set of money items is to be stored in a different one of the at least two separate money reservoirs and comprises money items of mixed denominations; selecting, from the at least two separate money item reservoirs, a first money item reservoir for receipt of one or more first money items of a first set; switching a configuration of the selected first money item reservoir to a money item receiving configuration; routing the one or more first money items into the selected first money reservoir while in the money item receiving configuration; selecting, from the at least two separate money item reservoirs, a second money item reservoir for receipt of one or more second money items of a second set; switching a configuration of the selected second money item reservoir to a money item receiving configuration; routing the one or more second money items into the selected second money reservoir while in the money item receiving configuration.

Switching a configuration of the selected second money item reservoir to a money item receiving configuration may further comprise switching a configuration of the selected first money item reservoir from a money item receiving configuration to a money item retention configuration in which money items cannot be received into the first money item reservoir.

The method may further comprise: re-selecting, from the at least two separate money item reservoirs, the first money item reservoir for receipt of one or more further first money items of the first set; switching a configuration of the re-selected first money item reservoir back to a money item receiving configuration; and routing the one or more further first money items into the re-selected first money reservoir while in the money item receiving configuration.

Switching a configuration of the re-selected first money item reservoir to a money item receiving configuration may further comprise switching a configuration of the selected second money item reservoir from a money item receiving configuration to a money item retention configuration in which money items cannot be received into the second money item reservoir.

The method may further comprise: re-selecting, from the at least two separate money item reservoirs, the second money item reservoir for receipt of one or more further second money items of the second set; switching a configuration of the re-selected second money item reservoir back to a money item receiving configuration; and routing the one or more further second money items into the re-selected second money reservoir while in the money item receiving configuration.

Switching a configuration of the re-selected second money item reservoir to a money item receiving configuration may further comprise switching a configuration of the first money item reservoir from a money item receiving configuration to a money item retention configuration in which money items cannot be received into the first money item reservoir.

The method may comprise: selecting, from the at least two separate money item reservoirs and sets of money items, a money item reservoir and a set of stored money items; switching a configuration of the selected money item reservoir from a money item retention configuration to a money item supply configuration; and supplying, from the selected money item reservoir in the money item supply configuration, the selected set of money items in response to a demand for money items.

The method may comprise selecting at least one individual money item from the supplied set of money items and dispensing the at least one selected money item to a user collection region.

This specification also provides a money item handling system comprising: an outer housing; a money item entry gate apparatus; and at least one further money item apparatuses inside the housing; wherein the money item entry gate apparatus is operable in a plurality of operation modes to selectively control a maximum flow rate of money items from an exterior of the housing into the at least one further money item apparatus inside the housing.

The money item entry gate apparatus may comprise a flow restriction element which is actuatable between a plurality of positions corresponding to the plurality of operation modes of the gate apparatus.

The operation modes may comprise: a first mode in which the flow restriction element fully blocks an entry aperture of the gate apparatus to prevent money items from reaching the at least one money item apparatus inside the housing; a second mode in which the flow restriction element fully partially blocks the entry aperture of the gate apparatus to permit a limited flow of money items to reach the at least one money item apparatus inside the housing; and a third mode in which the flow restriction element does not block the entry aperture of the gate apparatus to permit a maximum flow of money items to reach the at least one money item apparatus inside the housing.

The gate apparatus may further comprise a motor driven actuator configured to actuate the flow restriction apparatus relative to the entry aperture of the gate apparatus.

The actuator may be located inside the housing of the system and may be coupled to the flow restriction element by a mechanical arm.

The arm may be controllable to move the flow restriction element across the entry aperture so as to adopt any of the operation modes of the gate apparatus.

Example implementations are described below with reference to the accompanying figures.

### BRIEF DESCRIPTION OF THE DRAWINGS

FIG. 1 is a view of a section of a money item supply apparatus comprising a plurality of separate money item reservoirs;

FIG. 2 is a three-dimensional cut-away view of a money item supply apparatus comprising a plurality of separate money item reservoirs;

FIG. 3 is a three-dimensional illustration of a rotatable part of a money item supply apparatus comprising a plurality of separate money item reservoirs, where the apparatus is in a money item fill configuration for a first of the reservoirs;

FIG. 4 is a three-dimensional illustration of a rotatable part of a money item supply apparatus comprising a plurality of separate money item reservoirs, where the apparatus is in a money item supply configuration for a first of the reservoirs;

FIG. 5 is a three-dimensional illustration of a rotatable part of a money item supply apparatus comprising a plurality of separate money item reservoirs, where the apparatus is in a money item fill configuration for a second of the reservoirs;

FIG. 6 is a three-dimensional illustration of a rotatable part of a money item supply apparatus comprising a plurality of separate money item reservoirs, where the apparatus is in a money item supply configuration for a second of the reservoirs;

FIG. 7 is a three-dimensional illustration of a rotatable part of a money item supply apparatus comprising a plurality of separate money item reservoirs, where the apparatus is in a money item fill configuration for a third of the reservoirs;

FIG. 8 is a three-dimensional illustration of a rotatable part of a money item supply apparatus comprising a plurality of separate money item reservoirs, where the apparatus is in a money item supply configuration for a third of the reservoirs;

FIG. 9 is a three-dimensional illustration of a rotatable part of a money item supply apparatus comprising a plurality of separate money item reservoirs and further money item escrow, impounding or alternative utility regions;

FIG. 10 is a side on cut-away view of an automated money item handling system including a money item supply apparatus;

FIG. 11 is a side on cut-away view of a further example of an automated money item handling system including a money item supply apparatus;

FIG. 12 is a perspective cut-away view of the further example of an automated money item handling system including a money item supply apparatus;

FIG. 13A is a flow diagram of an operational process for a money item supply apparatus;

FIG. 13B is a further flow diagram of an operational process for a money item supply apparatus;

FIG. 14 is a perspective cut-away view of aspects of an automated money item handling system including a money item entry gate apparatus;

FIG. 15 is a perspective view of an exterior of an automated money item handling system including a money item entry gate apparatus, where the gate apparatus is fully closed;

FIG. 16 is a perspective view of an exterior of an automated money item handling system including a money item entry gate apparatus, where the gate apparatus is fully open;

FIG. 17 is a perspective view of an exterior of an automated money item handling system including a money item entry gate apparatus, where the gate apparatus is partially open;

FIG. 18 is a perspective cut-away view of part of an automated money item handling system including a money item entry gate apparatus, where the gate apparatus is closed;

FIG. 19 is a further perspective cut-away view of part of an automated money item handling system including a money item entry gate apparatus, where the gate apparatus is closed;

FIG. 20 is a further perspective cut-away view of part of an automated money item handling system including a money item entry gate apparatus, where the gate apparatus is partially open;

FIG. 21 is a further perspective cut-away view of part of an automated money item handling system including a money item entry gate apparatus, where the gate apparatus is fully open; and

FIG. 22 is a schematic diagram of aspects of a money item handling apparatus.

### DETAILED DESCRIPTION

Aspects of a money item handling system are described below. The money item handling system includes at least one region which is configured to receive money items, such as coins, from an external user and at least one further region which is configured to supply money items, such as coins, in response to demand. Aspects of the system have the capability to supply such money items, in accordance with the demand, with low delay and at a high rate whilst also permitting sustainable management of money item distributions and/or volumes within the system.

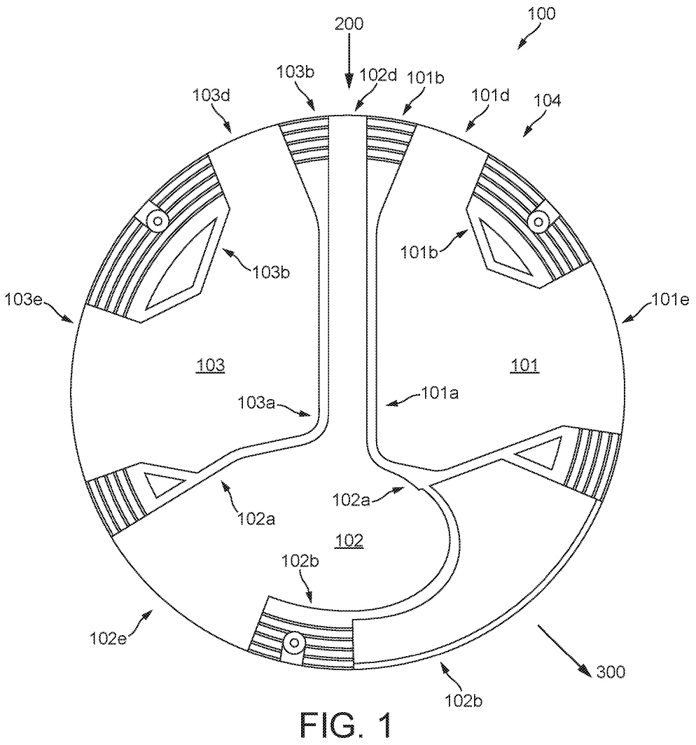

FIG. 1 illustrates a plurality of separate money item reservoirs 101-103 of a money item supply apparatus 100. The money item supply apparatus 100 operates as part of the wider money item handling system mentioned above. As will be explained below, the separate money item reservoirs 101-103 may each be configured to selectively retain money items in the supply apparatus 100 and/or to selectively supply money items from the supply apparatus 100. In particular, the money item reservoirs 101-103 may be selectively switchable between a money item retention configuration and a money item supply configuration in order to selectively retain money items stored in the reservoirs 101-103 and/or to selectively supply money items from the reservoirs 101-103 to other regions of the money item handling system.

The money item reservoirs 101-103 may also be selectively switchable into a money item receiving configuration. When in a money item receiving configuration, the reservoirs 101-103 are arranged to receive money items from other regions of the money item handling system so that the reservoirs 101-103 can be filled or refilled. The money item receiving configuration may be a sub configuration of the money item retention configuration, as explained further below with respect to FIG. 1.

Operation of the plurality of reservoirs 101-103 between the different operational configurations permits the money item handling system to be run in a highly flexible and adaptable manner so that specific demands on the system, whether transient or recurring and whether setting-specific or universal to all settings, can be efficiently met.

The plurality of money item reservoirs 101-103 illustrated in FIG. 1 comprise three money item reservoirs 101, 102, 103, although other pluralities of reservoirs could alternatively be used. Each of the reservoirs 101-103 comprises a money item storage region in which a plurality of money items can be stored separately from any other money items in the apparatus 100, including any money items in other reservoirs 101-103. For example, each money item reservoir 101-103 may be loaded with a set of money items which can be supplied from the reservoir 101-103 to meet a demand, such as a need to supply a specific value of money items to a user of the money item handling system. The set of money items in any particular reservoir 101-103 may be a predetermined mix of different denominations of money item. The set may be selected in order to ensure (or ensure a high probability) that any value of money items, up to a maximum value, such as the total value of the set, can be supplied using only money items from the set. In other words, the set may be selected so as to ensure that any value of money items, up to a certain maximum, can be supplied using only one reservoir 101-103. A process of selectively filling and refilling the individual reservoirs 101-103 with sets of money items, for example from an empty state or partially empty state of the reservoir, will be described further below.

In terms of structure, each money item reservoir 101-103 is defined by one or more boundaries, such as one or more boundary walls, within which money items are stored in the reservoir 101-103. For example, as shown in FIG. 1, one or more boundary walls 101a-b, 102a-b, 103a-b of each reservoir 101-103 may be shared with a neighbouring reservoir 101-103, so that the shared wall divides the neighbouring reservoirs and keeps the money items within them apart. The plurality of reservoirs 101-103 may, for example, be approximately equal in size and/or volume so as to accommodate similarly sized sets of money items. Alternatively, at least one of the reservoirs 101-103 may be significantly larger (e.g. 50%-100% larger) in size and/or volume than the other reservoir(s) 101-103 so that the larger reservoir(s) 101-103 can accommodate significantly more money items.

Each money item reservoir 101-103 comprises a money item inlet 101d, 102d, 103d and a money item outlet 101e, 102e, 103e. The money item inlets 101d-103d serve to allow money items to be selectively fed into the respective money item reservoirs 101-103, for example in order to fill or refill the respective reservoirs 101-103 when in a money item receiving configuration. The money item outlets 101e-103e serve to allow money items to be selectively dispensed from the respective money item reservoirs 101-103, for example in order to supply money items from the respective reservoirs 101-103 when in a money item supply configuration. Such money items may be supplied to other regions of the money item handling system.

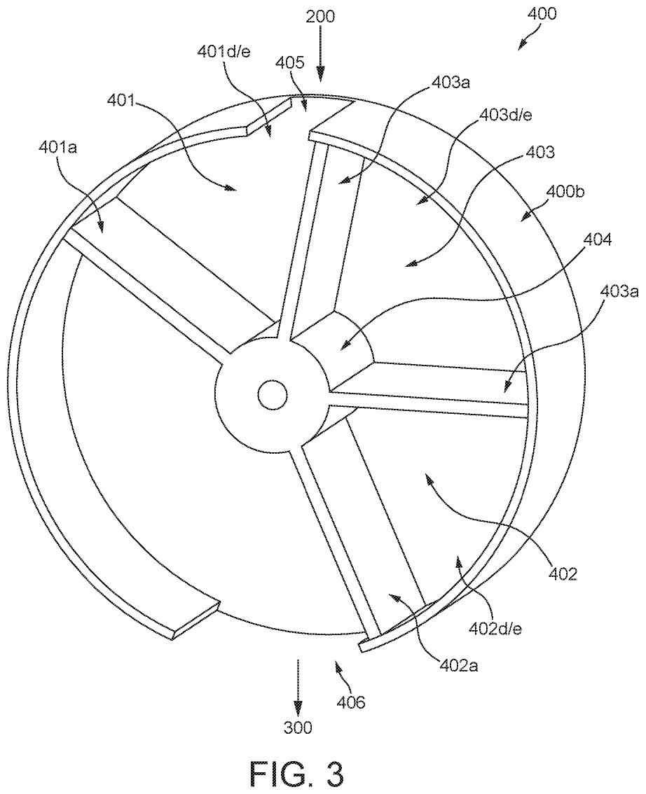

As explained further below, in some implementations of the money item supply apparatus 100, the inlet 101d-103d and outlet 101e-103e of each reservoir 101-103 may be separate from one another. An example of this is illustrated in FIG. 1. However, in other implementations, the inlet 101d-103d and outlet 101e-103e of each reservoir 101-103 may be provided by a shared inlet/outlet region for money items. An example of this is illustrated in FIGS. 3-8.

In the implementation illustrated in FIG. 1, the money item supply apparatus 100 comprises a rotatable apparatus 104 in which the plurality of money item reservoirs 101-103 are present. The rotatable apparatus 104 may have an approximately circular cross-sectional shape. Boundary walls 101a-b, 102a-b, 103a-b divide the rotatable apparatus 104 into the plurality of reservoirs 101-103. As can be seen, in addition to internal sections of wall 101a, 102a, 103a which divide up an interior region of the rotatable apparatus 104, each reservoir 101-103 may also comprise a section of circumferential wall 101b, 102b, 103b at the outer part of the rotatable apparatus 104. The money item inlet 101d-103d and the money item outlet 101e-103e of each reservoir 101-103 are provided as individual apertures in this outer part of the wall 101b, 102b, 103b. In other words, for each reservoir 101-103, a first aperture in the wall provides the inlet 101d-103d and a second aperture in the wall provides the outlet 101e-103e.

The apertures for the inlets 101d-103d and outlets 101e-103e of the reservoirs 101-103 may be spaced around the perimeter of the apparatus 104. For example, as illustrated in FIG. 1, the inlets 101d-103d of the plurality of reservoirs 101-103 may be grouped closely together in a row, for example over less than a quarter of the total length of the circumferential perimeter of the rotatable apparatus 104, in an inlet region of the apparatus 104. The reservoir outlets 101e-103e may be spaced at approximately equal intervals in a row around the remainder of the circumferential perimeter in an outlet region of the apparatus 104. The regions between the inlets 101d-101e may comprise uninterrupted sections of the outer wall referred to above. The regions between the outlets 101e-103e may also be made up of uninterrupted sections of the outer wall.

As can be seen from FIG. 1, the money item inlets 101d, 103d of the first and third money item reservoirs 101, 103 may be located in the outer wall 101b-103b of the rotatable apparatus 104 at points which are directly adjacent to the first and third reservoirs 101, 103, respectively. The money item inlet 102d of the second money item reservoir 102, on the other hand, may be located in the outer wall 101b-103b at a point which is not adjacent to the second money item reservoir 102. In FIG. 1, for example, the money item inlet 102d of the second money item reservoir 102 is located in the outer wall at a point which is approximately radially opposite to the second money item reservoir 102. In contrast to the first and third inlets 101d, 103d, whose apertures open directly into the associated reservoirs 101, 103, the second money item inlet 102d comprises a channel which passes from the aperture in the outer wall through the centre of the rotatable apparatus 104 and opens into the second reservoir 102 on the opposite side of the rotatable apparatus 104. In doing so, the channel passes between the first and third reservoirs 101, 103.

In order to switch each reservoir 101-103 of the money item supply apparatus 100 between the different configurations mentioned above, the inlets 101d-103d and outlets 101e-103e may be selectively aligned and unaligned with money item input and output routings of the money item handling system. This may be achieved by selectively rotating the rotatable apparatus 104 to align the various inlets 101d-103d and outlets 101e-103e with input and output routings of the handling system, as described further below. Movement of the supply apparatus 100 between the different configurations may be implemented by use of a motor-driven actuator 108 which is mechanically coupled to the rotatable apparatus 104. For example, the actuator 108 may engage with a plurality of drivable elements 109 on the rear of the rotatable apparatus 104. The actuator 108 may drive the rotatable apparatus 104 between discrete rotational positions corresponding to the positions of the driveable elements 109.

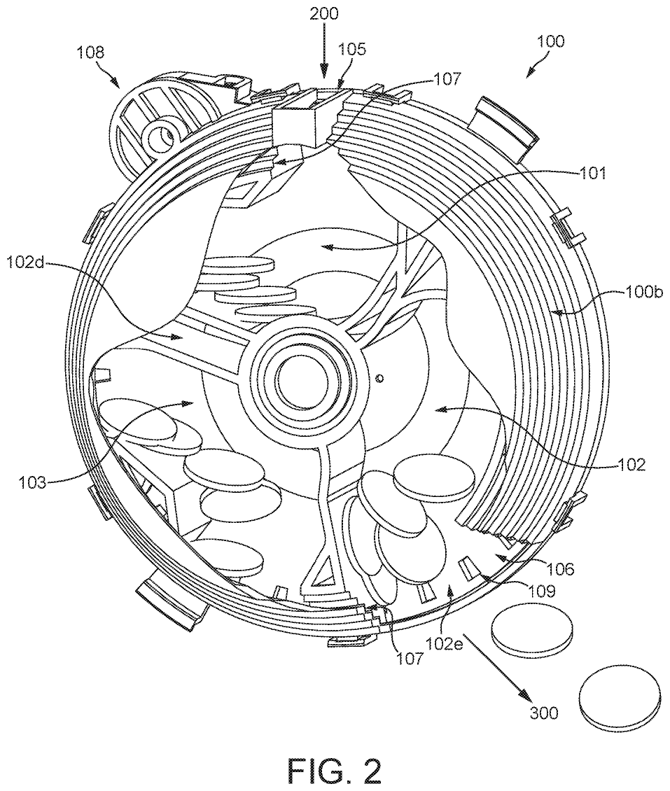

As best shown in FIG. 2, the rotatable apparatus 104 may be configured to rotate within a fixed perimeter wall 100b of the supply apparatus 100. A money item entry aperture 105 in the fixed perimeter wall 100b is fixedly aligned with a money item input routing 200 for the supply apparatus 100. Additionally, a separate money item exit aperture 106 in the fixed perimeter wall 100b, which is spaced from the entry aperture 105 in a lower part of the supply apparatus 100, is fixedly aligned with a money item output routing 300 for the supply apparatus 100. In order to adopt the money item receiving configuration of any of the money item reservoirs 101-103, the rotatable apparatus 104 may be rotated so as to selectively align the inlet 101d-103d of the respective reservoir 101-103 with the money item entry aperture 105 and input routing 200. Likewise, in order to adopt the money item supply configuration of any of the money item reservoirs 101-103, the rotatable apparatus 104 may be rotated so as to selectively align the outlet 101e-103e of the respective reservoir 101-103 with the money item exit aperture 106 and output routing 300.

FIG. 1 schematically illustrates the money item inlet routing 200 and the money item outlet routing 300 relative to the reservoirs 101-103 of the money item supply apparatus 100. In particular, the inlet and outlet routings 200, 300 are shown as arrows in the locations of the routings 200, 300. The direction of the arrows shows the direction of travel for money items in the routings 200, 300. These directions of travel may be dictated by gravity in combination with the geometry (e.g. angles) of the routings 200, 300. As can be seen, in the illustrated position of the supply apparatus 100, the inlet 102d of the second money item reservoir 102 is aligned with the exit of the money item input routing 200 so that the second reservoir 102 may be filled (or partially filled) with money items from the routing 200. This is the money item receiving configuration of the second reservoir 102, in which money items may pass through the exit of the input routing 200 into the inlet 102d of the second reservoir 102. Such money items are then retained in the second reservoir 102 until the reservoir 102 is moved to its supply configuration, as discussed in more below.

It can be seen from FIG. 1 that, by rotating the rotatable apparatus 104 a short distance in a first (e.g. clockwise) direction, the inlet 103d of the third money item reservoir 103 will become aligned with the fixed money item input routing 200 so that the third reservoir 103 may be filled from the routing 200. At the same time, the inlet 102d of the second reservoir 102 will become unaligned with the routing 200. As such, the third reservoir 103 will switch from a general money item retention configuration to a specific money item receiving configuration whilst the second reservoir 102 will switch from a specific money item receiving configuration to a general money item retention configuration.

Likewise, it can be further seen from FIG. 1 that, by rotating the rotatable apparatus 104 a short distance in a second (e.g. anti-clockwise) direction, the inlet 101d of the first money item reservoir 101 will become aligned with the money item input routing 200 so that the first reservoir 101 may be filled from the routing 200. At the same time, the inlet 102d of the second reservoir 102 (or the inlet 103d of the third reservoir 103, depending on the starting position of the rotatable apparatus 104) will become unaligned with the routing 200. As such, the first reservoir 101 will switch from a general money item retention configuration to a specific money item receiving configuration whilst the second reservoir 102 (or third reservoir 103, depending on the starting position of the rotatable apparatus 104) will switch from a specific money item receiving configuration to a general money item retention configuration.

In the implementation shown in FIG. 1, only one of the plurality of reservoirs 101-103 can be in a money item receiving configuration at any one time. That is, when any one of the plurality of money item reservoirs 101-103 is in a money item receiving configuration, the others of the plurality of money item reservoirs 101-103 are in a general money item retention configuration rather than a specific receiving configuration. When in such a general money item retention configuration, the inlet of a money item reservoir is not aligned with the money item input routing 200 and so does not receive money items from the input routing 200. For the apparatus illustrated in FIG. 1, the general retention configuration is one in which the reservoir is arranged to retain money items without simultaneously permitting money items to be received from the input routing 200. The receiving configuration, on the other hand, is one in which the reservoir is arranged to simultaneously retain money items and permit money items to be received from the input routing 200.

An effect of spacing the plurality of reservoir inlets 101d-103d closely together, as shown in FIG. 1, is to allow the supply apparatus 100 to be quickly switched between the money item receiving configurations of the different reservoirs 101-103. In particular, the rotatable apparatus 104 needs to be rotated only a short distance when moving between the different money item receiving configurations. This can be advantageous when filling the different reservoirs 101-103 with new or replacement money items because, by rapidly and selectively switching the various reservoirs 101-103 between their receiving and retention configurations, individual, pre-denominated money items moving towards the supply apparatus 100 through the input routing 200 can be selectively fed into selected ones of the reservoirs 101-103. This may be used to fill or refill each of the reservoirs 101-103 with specific sets of money items, where each set comprises a predetermined mix of money item denominations. Similarly, where one or more reservoirs contain only a partial set of money items, the partial set(s) may be completed as full set(s) by routing particular denominations of money items into the appropriate reservoirs.

As outlined above, each of the plurality of money item reservoirs 101-103 is also selectively operable in a money item supply configuration. In order to supply money items from the reservoirs 101-103, the money item outlets 101e-103e of any of the reservoirs 101-103 may be selectively aligned with the money item output routing 300. An example position of the money item outlet routing 300 is illustrated in FIG. 1. As shown there, the money item outlet routing 300 is spaced from the money item input routing 200 so that money items enter the supply apparatus 100 at a different location, and from a different angle, to that from which they are ultimately supplied from the supply apparatus 100. When any one of the reservoirs 101-103 is in a money item supply configuration, the others of the reservoirs 101-103 are in money item retention configurations. This can be seen from FIG. 1.

An example of a money item supply configuration is illustrated in FIG. 2. In this figure, it can be seen that the second money item reservoir 102 has its outlet 102e aligned with the output routing 300 referred to above. In this supply configuration of the second reservoir 102, money items in the second reservoir 102 naturally flow out of the reservoir 102 under gravity and move into the output routing 300. This allows the second reservoir 102 to be emptied of money items. Meanwhile any money items in the other reservoirs 101, 103 are retained in the supply apparatus 100.

It can be seen from FIG. 2 (and FIG. 1) that, by rotating the rotatable apparatus 104 in a first (e.g. clockwise) direction, the outlet 101e of the first money item reservoir 101 will become aligned with the money item output routing 300 so that the first reservoir 101 empties money items into the routing 300. At the same time, the outlet 102e of the second reservoir 102 will become unaligned with the routing 300. As such, the first reservoir 101 will switch from a money item retention configuration to a money item supply configuration whilst the second reservoir 102 will switch from a money item supply configuration to a money item retention configuration.

Likewise, it can be further seen from FIG. 2 (and FIG. 1) that, by rotating the rotatable apparatus 104 in a second (e.g. anti-clockwise) direction, the outlet 103e of the third money item reservoir 103 will become aligned with the money item output routing 300 so that the third reservoir 103 may empty money items into the routing 300. At the same time, the outlet 102e of the second reservoir 102 (or the outlet 101e of the first reservoir 101, depending on the starting position of the rotatable apparatus 104) will become unaligned with the routing 300. As such, the third reservoir 103 will switch from a money item retention configuration to a money item supply configuration whilst the second reservoir 102 (or first reservoir 101, depending on the starting position of the rotatable apparatus 104) will switch from a money item supply configuration to a money item retention configuration.

In the implementation shown in FIG. 1, only one of the plurality of reservoirs 101-103 can be in a money item supply configuration at any one time. That is, consistent with the discussion above, when any one of the plurality of money item reservoirs 101-103 is in a money item supply configuration, the others of the plurality of money item reservoirs 101-103 are in a money item retention configuration.

As best illustrated in FIG. 2, one or more surfaces of the rotatable apparatus 104 and one or more corresponding surfaces of the fixed perimeter wall 100b may each comprise one or more mating elements 107, such as ridges and grooves, which fit together. The mating elements 107, when fitted together, permit free rotation of the rotatable apparatus 104 with respect to the perimeter wall 100b, while ensuring that money items or debris cannot pass from one reservoir to another via a gap between the rotatable apparatus 104 and the inside of the perimeter wall 100b.

As will be discussed in more detail below in the detailed explanation of operational processes, the plurality of money item reservoirs 101-103 of the supply apparatus 100 may be ranked in order of preference for supplying money items. In particular, for the purposes of supplying money items in order to meet a demand for money items elsewhere in the money item handling system, each of the different reservoirs 101-103 may be more or less preferred, relative to individual ones of the other reservoirs 101-103, depending on its position in the supply apparatus 100 relative to others of the reservoirs 101-103.

For example, in the implementation illustrated in FIG. 1, the first money item reservoir 101 may be the most preferred for supplying money items, the second money item reservoir 102 may be the second most preferred (or less preferred) for supplying money items, and the third money item reservoir 103 may be the third (or least) most preferred for supplying money items. It is notable in this regard that, when starting from the orientation of the apparatus 104 illustrated in FIG. 1, in which the money item inlets 101d-103d of the reservoirs 101-103 are positioned close to, or aligned with, the money item input routing 200, the apparatus 104 may be re-orientated to switch either of the first or second reservoir 101, 102 into a money item supply configuration without, in doing so, switching another of the reservoirs 101-103, even temporarily, into a money item supply configuration. For the third reservoir 103, this is not the case because orientating the apparatus 104 to align the outlet 103e of the third reservoir 103 with the output routing 300 means passing through the money item supply configuration of one or the other of the first and second reservoirs 101, 102. Of course, where alternative structures of money item supply apparatus 100 are used, the preference order of individual reservoirs may be different. Furthermore, where not all of the money item reservoirs 101-103 comprise a full set of money items, the preference order of the reservoirs 101-103 may be dynamically adjusted in order to maximise the possibility of the supply apparatus 100 being able to supply any particular monetary value using only a single reservoir 101-103. For example, where the second reservoir 102 comprises a full set of money items but the first reservoir 101 comprises only a partial set of money items, the second reservoir 102 may become the most preferred reservoir for supply operations. This situation may occur where the first reservoir 101 has recently been emptied and has not yet been fully refilled with a complete money item set.

Another matter to note with regard to the preference order of the plurality of reservoirs 101-103 for supply operations is that, in the supply apparatus 100 illustrated in FIG. 1 and as generally described herein, there are no actuatable gates to control the flow of money items into and out of the supply apparatus 100 via the input and output routings 200, 300 discussed above. Instead, whether or not money items in the input routing 200 enter the individual reservoirs 101-103 is entirely controlled by selective alignment of the money item inlets 101d-103d of the reservoirs 101-103 with an open end of the input routing 200. Similarly, whether or not money items in the individual reservoirs 101-103 enter the output routing 300 is entirely controlled by selective alignment of the money item outlets 101e-103e of the reservoirs 101-103 with an open end of the output routing 300. This implementation of the supply apparatus 100 and input/output routings 200, 300 may improve the reliability of the supply apparatus (e.g. by removing the potential for gate failure) and may also save manufacturing cost. However, the lack of actuatable gates at the input/output routings 200, 300 and/or at the inlets/outlets 101d-103d, 101e-103e is an optional aspect of the supply apparatus 100. Such gates could readily be included in alternative implementations of the supply apparatus 100 and, indeed, the inclusion of such gates is explicitly contemplated herein as an optional aspect of the supply apparatus 100.

Another example implementation of the money item supply apparatus 400 is illustrated in FIGS. 3-8. As with the example shown in FIGS. 1 and 2, the implementation of the supply apparatus 400 shown in FIGS. 3-8 comprises a plurality of money item reservoirs 401-403 which are each selectively switchable between different operational configurations, including a money item retention configuration, a money item supply configuration and a money item receiving configuration. Each of the reservoirs 401-403 comprises a money item storage region in which a set of money items can be stored separately from any other money items in the apparatus 400, including any sets of money items in the other reservoirs 401-403.

Structurally, as with example shown in FIGS. 1 and 2, each money item reservoir 401-403 is defined by one or more boundaries, such as one or more boundary walls, within which money items are stored in the reservoir 401-403. In particular, as shown in FIG. 3, one or more boundary walls 401a, 402a, 403a of each reservoir 401-403 may be shared with a neighbouring reservoir 401-403, so that the shared wall divides the neighbouring reservoirs and keeps the money items within them apart.

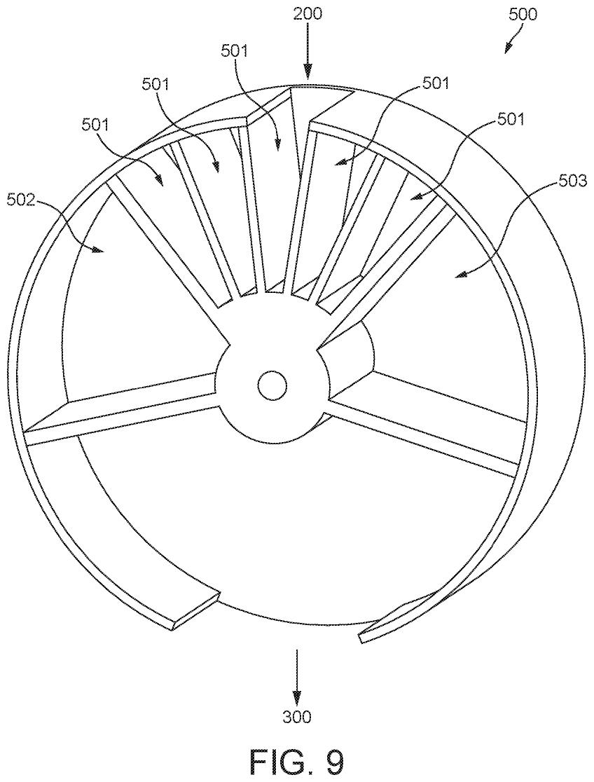

As with other implementations, the plurality of reservoirs 401-403 may be approximately equal in size and/or volume so as to accommodate similarly sized sets of money items. Alternatively, the reservoirs 401-403 may be different in size and/or volume as discussed in more detail with respect to FIG. 9.

Each money item reservoir 401-403 also comprises a money item inlet and outlet through which money items may be selectively received into, and supplied from, the reservoirs 401-403. Whereas in the example of FIGS. 1 and 2, the money item inlets 101s-103d and outlets 101e-103e of each reservoir 101-103 are provided by separate apertures in an outer boundary wall of the rotatable apparatus 104, in the alternative example of FIGS. 3-8 the money item inlet 401d and money item outlet 401e of each reservoir 401-403 is provided by a shared entry and exit region of each respective reservoir 401-403. As with the example shown in FIGS. 1 and 2, in the example of FIGS. 3-8 a rotatable apparatus 404 comprising the dividing walls 401a-403a mentioned above is configured to rotate within a fixed perimeter wall 400b of the supply apparatus 100. The dividing walls 401a-403a extend radially outward from the centre of the rotatable apparatus 404 to meet the perimeter wall 400b, whilst ensuring there is little to no frictional resistance at the meeting point. The open areas between each pair of radial dividing walls 401a-403a provide the shared entry and exit regions of the plurality of reservoirs 401-403.

As shown in FIG. 3, a money item entry aperture 405 in the fixed perimeter wall 400b is fixedly aligned with the money item input routing 200. Additionally, a separate money item exit aperture 406 in the fixed perimeter wall 400b, which is spaced from the entry aperture 405 in a lower part of the supply apparatus 400, is fixedly aligned with the money item output routing 300. In order to adopt the money item receiving configuration of any of the money item reservoirs 401-403, the rotatable apparatus 404 may be rotated so as to selectively align the shared entry and exit region of the respective reservoir 401-403 with the money item entry aperture 405 and input routing 200. Likewise, in order to adopt the money item supply configuration of any of the money item reservoirs 401-403, the rotatable apparatus 404 may be rotated so as to selectively align the shared entry and exit region of the respective reservoir 401-403 with the money item exit aperture 406 and output routing 300. Non-alignment between the shared entry and exit region of any of the reservoirs 401-403 corresponds to the reservoir's money item retention configuration.

In common with the structure shown in FIGS. 1 and 2, the inlets 401d-403d and outlets 401e-403e of the reservoirs 401-403 are spaced around the circumferential perimeter of the rotatable apparatus 404. Furthermore, as with the structure shown in FIGS. 1 and 2, the plurality of reservoir inlets 401d-403d are grouped relatively closely together. For example, the plurality of reservoir inlets 401d-403d may be grouped over less than half, such as approximately a quarter, or less than a quarter, of the total length of the circumference of the rotatable apparatus 404. In this instance, the same is also true of the plurality of reservoir outlets 401e-403e, meaning that relative small rotations of the rotatable apparatus 404 can be used to switch between the money item supply configurations of any of the reservoirs 401-403.

In a similar manner to the supply apparatus shown in FIGS. 1 and 2, the supply apparatus 400 of FIGS. 3-8 does not comprise gates at the entry aperture 405 or exit aperture 406. Instead, flow of money items into and out of the supply apparatus 400 is dictated by gravity and the selective alignment/non-alignment of the money item inlets 401d-403d and outlets 401e-403e of the different reservoirs 401-403. For the same reasons as explained above in relation to FIGS. 1 and 2, the most preferred of the reservoirs for money item supply operations is the first reservoir 401. This is followed by the second reservoir 402 and, lastly, the third reservoir 403.

To provide an illustrated scenario of the various possible operational configurations of the money item supply apparatus 400, there now follows a description of a series of movements of the supply apparatus 400 with respect to FIGS. 3-8. Although this description is given particularly in the context of the implementation shown in those figures, it will be appreciated that a corresponding series of movements can result in the corresponding operational configurations of other implementations of the supply apparatus 400, including the supply apparatus 100 shown in FIGS. 1 and 2.

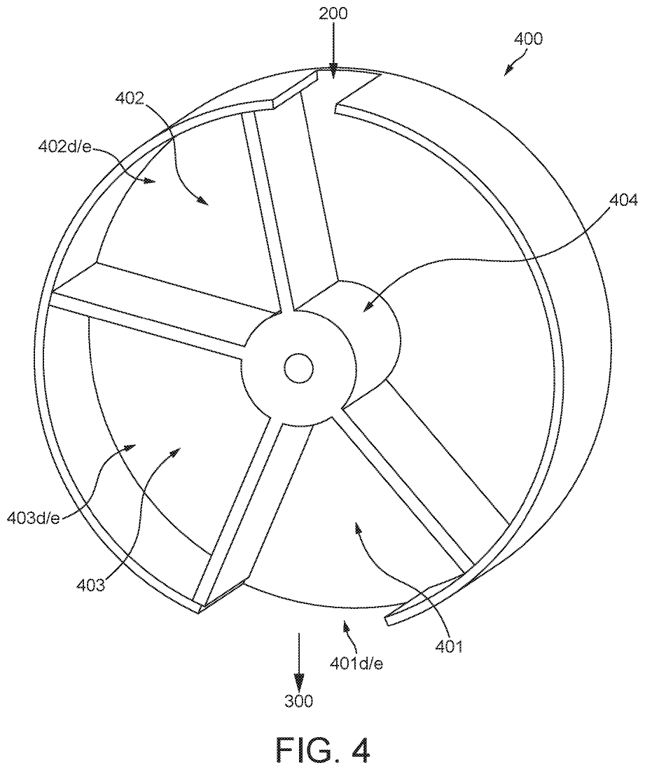

In FIG. 3, the first reservoir 401 of the supply apparatus 400 is in a money item receiving configuration in which the money item inlet 401d of the first reservoir 401 is aligned with the money item input routing 200 of the wider money item handling apparatus. The other reservoirs 402, 403 of the supply apparatus 400 are in money item retention configurations, in which the inlets 402d, 403d and outlets 402e, 403e of the reservoirs 402, 403 are non-aligned with the input routing 200 and output routing 300. Consistent with the description above, none of the reservoirs 401-403 is in a money item supply configuration. In FIG. 4, the first reservoir 401 has been switched to a money item supply configuration in which the money item outlet 401e of the first reservoir 401 is aligned with the money item output routing 300. The other reservoirs 402, 403 of the supply apparatus 400 remain in money item retention configurations, in which the outlets 402e, 403e of the reservoirs 402, 403 are non-aligned with the output routing 300.

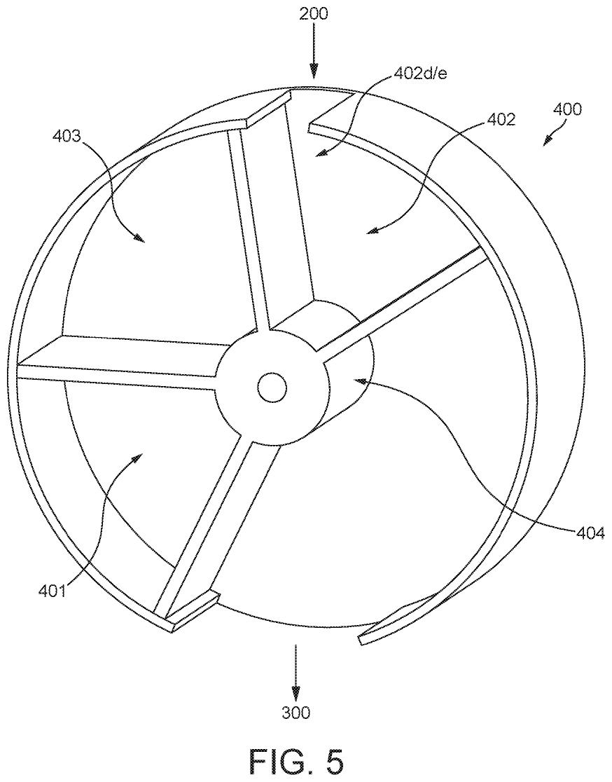

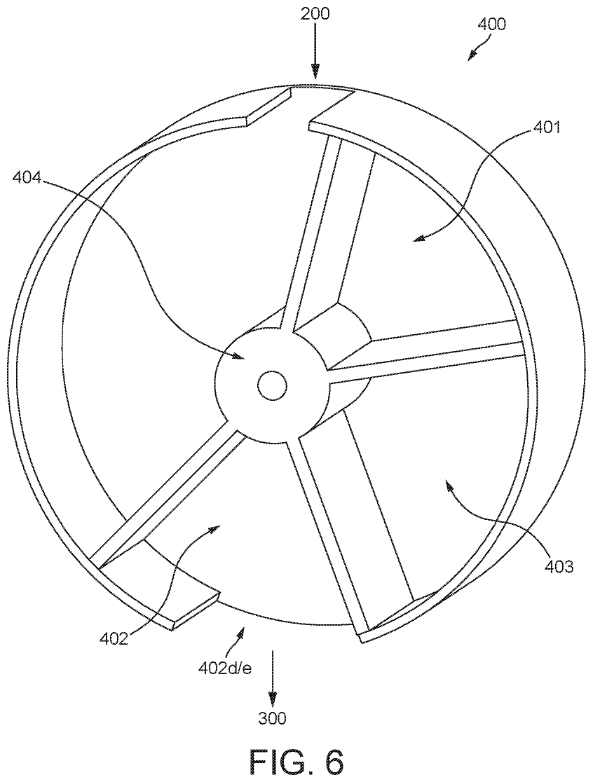

In FIG. 5, the second reservoir 402 of the supply apparatus 400 is in a money item receiving configuration in which the money item inlet 402d of the second reservoir 402 is aligned with the money item input routing 200 of the money item handling apparatus. The other reservoirs 401, 403 of the supply apparatus 400 are in money item retention configurations, in which the inlets 401d, 403d and outlets 401e, 403e of the reservoirs 401, 403 are non-aligned with the input routing 200 and output routing 300. In FIG. 6, the second reservoir 402 has been switched to a money item supply configuration in which the money item outlet 402e of the second reservoir 402 is aligned with the money item output routing 300. The other reservoirs 401, 403 are again in their money item retention configurations.

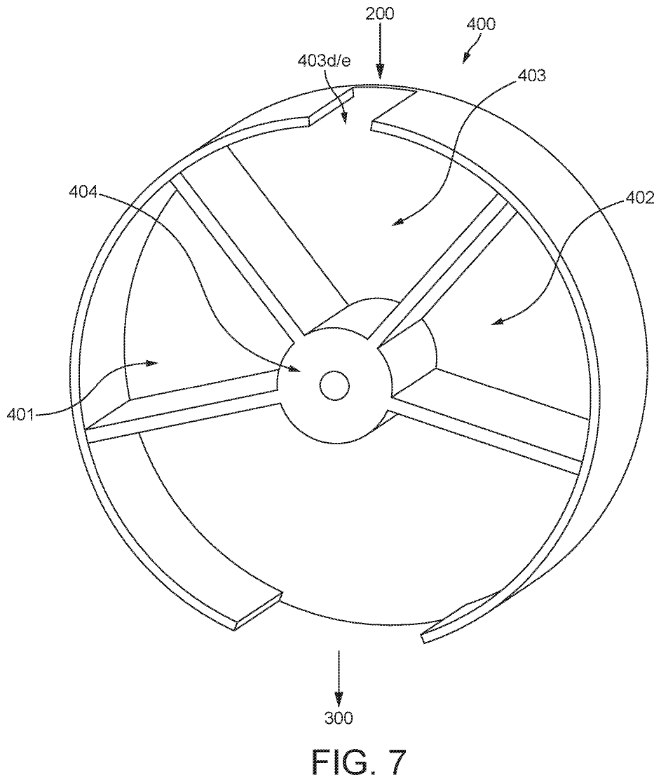

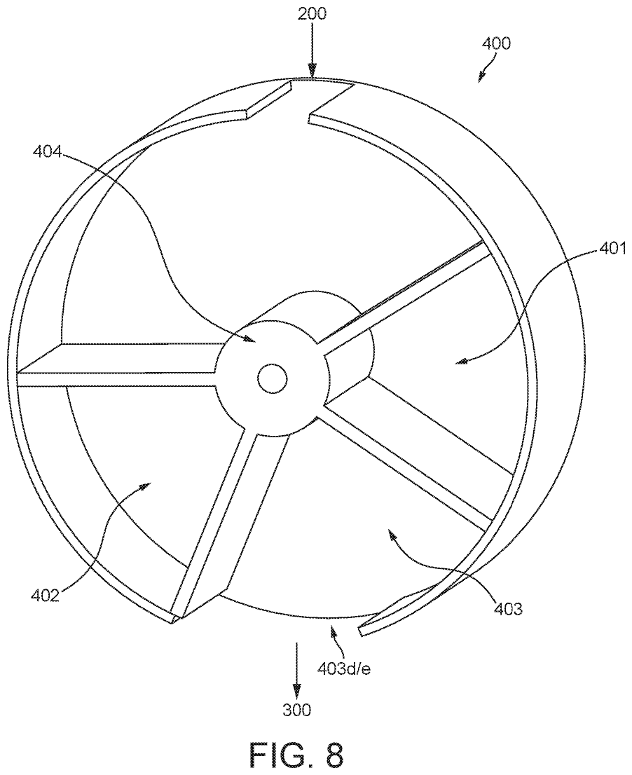

In FIG. 7, the third reservoir 403 is in a money item receiving configuration in which the money item inlet 403d of the third reservoir 403 is aligned with the money item input routing 200. The other reservoirs 401, 402 are in money item retention configurations, in which the inlets 401d, 402d and outlets 401e, 402e of the reservoirs 401, 402 are non-aligned with the input routing 200 and output routing 300. In FIG. 8, the third reservoir 403 has been switched to a money item supply configuration in which the money item outlet 403e of the third reservoir 403 is aligned with the money item output routing 300. The other reservoirs 401, 402 are again in their money item retention configurations.

FIG. 9 illustrates an example of a money item supply apparatus 500 in which, in addition to a plurality of supply reservoirs 502, 503 of the kind described above in relation to FIGS. 1-8, one or more further money item reservoirs serve as alternative utility regions. In particular, the supply apparatus 500 may be specially adapted for impounding or otherwise isolating particular money items received at the supply apparatus 500 from the input routing 200. As shown in FIG. 9, the supply apparatus 500 comprises one or more isolation reservoirs 501 in which single or multiple money items can be held in temporally unrestricted isolation from the remainder of the money items in the system. As with the other money item reservoirs 101-103, 401-403 described above with respect to FIGS. 1-8, a shared inlet/outlet of any one of the isolation reservoirs 501 can each be selectively aligned and unaligned with the money item input routing 200 so as to adopt a money item receiving configuration and/or a money item retention configuration. Furthermore, in order to empty any one of the isolation regions 501, the shared inlet/outlet of the isolation reservoir 501 may be aligned with the outlet routing 300 so as to cause the money item(s) in the isolation reservoir 501 to exit the supply apparatus 500 and enter the outlet routing 300. This is akin to the supply configuration of the reservoirs 101-103, 401-403 described above. Depending on the location of the inlet/outlet of any particular isolation reservoir 501 relative to the inlet/outlet(s) of the other reservoirs 502, 503, it may be necessary to empty one or more of the other reservoirs 502, 503 before emptying the isolation reservoir 501. For example, in the supply apparatus illustrated in FIG. 9, it is necessary to empty at least one of the supply reservoirs 502, 503 before emptying any of the isolation reservoirs 501 by selectively alignment with the outlet routing 300.

In an alternative approach which does not require aligning the inlet/outlet(s) of the isolation reservoir(s) 501 with the output routing 300, the isolated money items may be retained in a money item receiving configuration of the respective isolation reservoir 501 until such a time as a service person, or other authorized person, opens the money item handling system and removes the isolated money item.

The functionality of the supply apparatus 500 can be used to automatically isolate and impound money items which have been deemed fraudulent, or likely fraudulent, by one or more validation sensors elsewhere in the money item handling system. Once deemed fraudulent, a money item can be conveyed and tracked through the money item handling system to the money item input routing 200, from which it is selectively deposited into an isolation reservoir 501 of the supply apparatus 500.

Additionally or alternatively, the functionality of the supply apparatus 500 may be used to isolate particular denominations of money item so that such denominations are immediately available for supply if required. For example, if a particular denomination of money item is known to be rare in the money item handling system as a whole, the supply apparatus 500 may be used to isolate any money item(s) with the rare denomination as soon as it/they are discovered in the system.

The position of the one or more money item isolation reservoirs 501 may be selected so as to permit the supply apparatus 500 to continue to function normally, in terms of regular money item receiving and supply operations, even when money items are present in the isolation region(s) 501. For example, as shown in FIG. 9 and briefly discussed above, the one or more isolation reservoirs 501 may be located relative to the other money item reservoirs 502, 503 in such a way that allows the other money item reservoirs 502, 503 to be switched between any and all of their money item receiving, retention and supply configurations without ever necessarily switching the one or more isolation reservoirs 501 into a supply configuration as part of the switching.

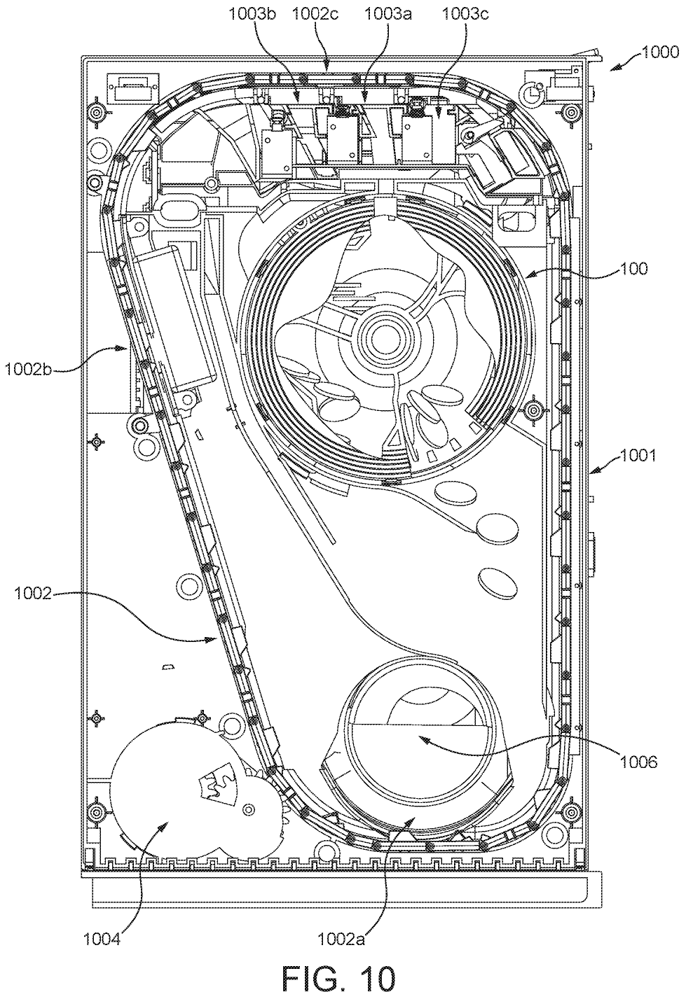

FIG. 10 shows the money item supply apparatus 100 in the context of the money item handling system 1000 mentioned repeatedly above. The specific implementation of the supply apparatus 100 included in FIG. 10 is the one discussed above with respect to FIGS. 1 and 2. However, other implementations of the supply apparatus, such as those shown in FIGS. 3-9, could equally be used.

As shown in FIG. 10, the money item supply apparatus 100 may be located within a central region of the money item handling system 1000 and, as with other components of the handling system 1000, is protected by an outer housing 1001 of the system 1000. A money item conveyor 1002 of the handling system 1000, which may be an endless belt conveyor, is configured to singulate and convey money items around a path of the conveyor 1002 from a money item receiving region 1002a of the conveyor 1002 to a money item exit region 1002c of the conveyor 1002. On route between the money item receiving region 1002a and the exit region 1002c, the money items on the conveyor 1002 pass through a money item sensing region 1002b of the conveyor 1002 in which the money items are denominated by one or more money item sensors positioned adjacent to the conveyor 1002. The money items may also be validated in the sensing region 1002b so as to identify any potentially invalid money items (e.g. for impounding in the isolation reservoirs 501 mentioned above).

The money item exit region 1002c of the conveyor 1002 comprises a plurality of money item exit gates 1003a-c, which are operable to selectively route individual money items off the conveyor 1002 into other regions of the money item handling system 1000. At least one of the money item exit gates 1003a is configured to feed money items from the conveyor 1002 into the money item input routing 200 discussed above, so that particular money items on the conveyor 1002 may be actively selected from the conveyor and routed into one or more selected reservoirs 101-103 of the supply apparatus 100.

For example, consider a scenario in which the first, second and third money item reservoirs 101-103 shown in FIG. 1 are initially empty and are each to be filled with a predetermined set of different denominations of money items. As singulated money items move around the path of the conveyor 1002 from the receiving region 1002a, the denomination of each money item and its position on the conveyor 1002 is determined in the sensing region 1002b so that the denomination of each money item arriving at the exit gates 1003a-c is known to the system 1000. By selective operation of the appropriate money item exit gate 1003a and selective, rapid switching between the money item receiving configurations of the different reservoirs 101-103 of the supply apparatus 100, each reservoir 101-103 of the supply apparatus 100 can be selectively and controllably filled with its predetermined set of money items. Money items on the conveyor 1002 which are not required for any of the reservoirs 101-103 are either routed off the conveyor 1002 to another region of the system 100, for example by another of the exit gates 1003b-c, or simply allowed to remain on the conveyor 1002.

As shown in FIG. 10, movement of the conveyor 1002 is controllably driven by a drive motor and associated drive apparatus 1004. The drive motor 1004 may, for example, be coupled to a drive gear (not shown) which engages with a driveable surface, such as a toothed surface, on the opposite side of the conveyor 1002 to the surface on which money items are received and conveyed to the exit region 1002c.

Money items are received on the conveyor 1002, in the money item receiving region 1002a mentioned above, from a money item storage region. The money item storage region may store a large number of mixed denomination money items (e.g. all denominations used in the system 1000). A flow of money items from the money item storage region (not visible in figure to the receiving region 1002a of the conveyor 1002 may be controlled by a money item flow control apparatus 1006, which is actuatable by a motor-driven actuator (not shown) to selectively control movement of money items from the mixed denomination money item storage region to the money item collection region 1002a of the conveyor 1002.

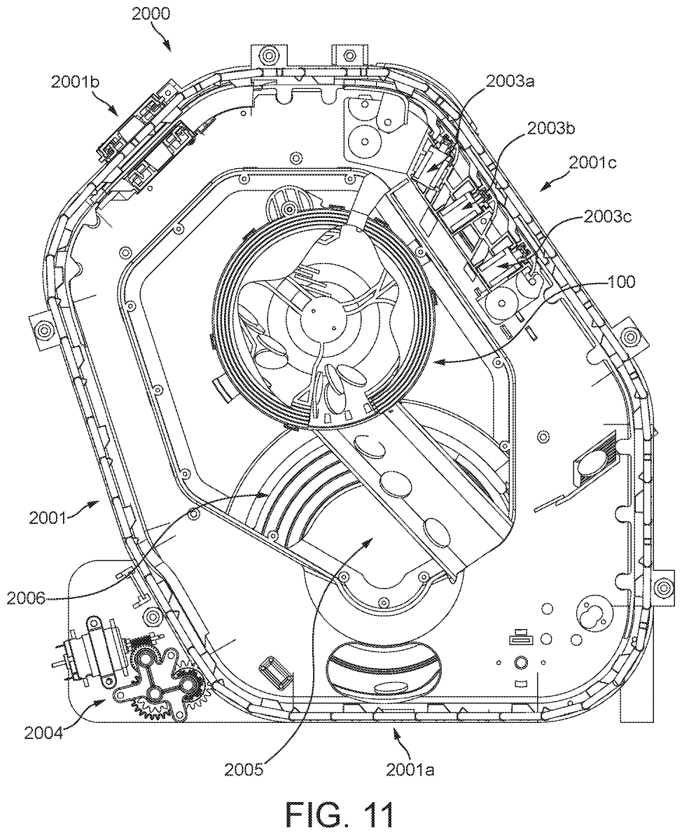

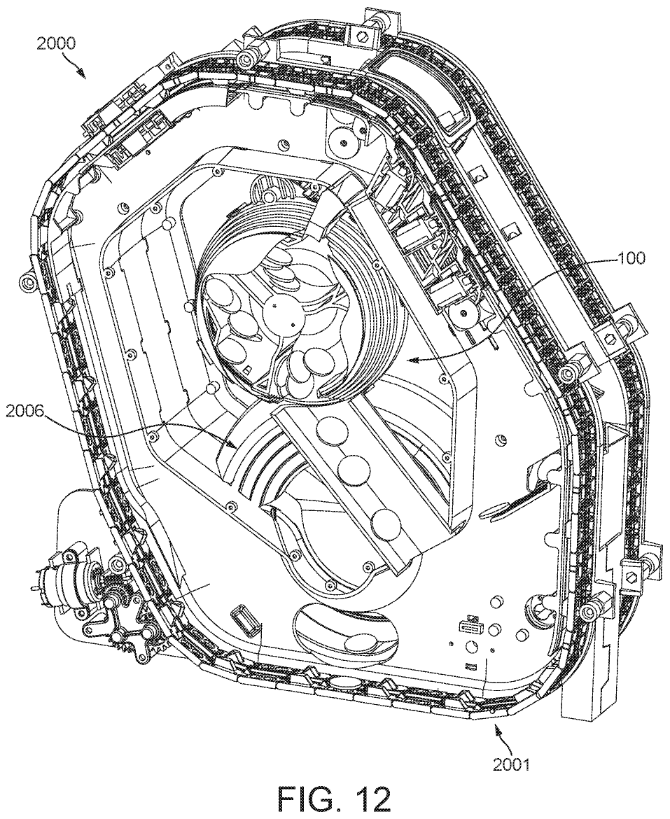

A further example of a money item handling system 2000 comprising the money item supply apparatus 100 is shown in FIGS. 11 and 12. As with FIG. 10, the specific implementation of the supply apparatus 100 included in FIGS. 11 and 12 is the one discussed above with respect to FIGS. 1 and 2. However, other implementations of the supply apparatus, such as those shown in FIGS. 3-9, could equally be used.

The description of the components and operational function of the money item handling system 1000 discussed above with respect to FIG. 10 applies also to the system illustrated in FIGS. 11 and 12. The system 2000 comprises a money item conveyor 2001 with a path that includes a money item receiving region 2001a, a money item sensing region 2001b and a money item exit region 2001c. The money item exit region 2001c comprises a plurality of money item exit gates 2003a-c, which are operable to selectively route individual money items off the conveyor 2001 into other regions of the money item handling system 2000. At least one of the money item exit gates 2003a is configured to feed money items from the conveyor 2001 into the money item input routing 200 discussed above, so that particular money items on the conveyor 2001 may be actively selected from the conveyor 2001 and routed into one or more selected reservoirs 101-103 of the supply apparatus 100. Movement of the conveyor 2001 is controllably driven by a drive motor and associated drive apparatus 2004 in the same manner as already discussed. Money items are received in the money item receiving region 2001a of the conveyor 2001 from a principal money item storage region 2005 of the system 2000. The money item storage region 2005 may store a large number of mixed denomination money items (e.g. all denominations used in the system 1000). A flow of money items from the money item storage region 2005 to the receiving region 2001a of the conveyor 2001 is controlled by a money item flow control apparatus 2006, which is actuatable to selectively control movement of money items from the mixed denomination money item storage region 2005 to the money item collection region 2001a. The handling system 2000 is housed within an outer housing (not shown in FIG. 11).

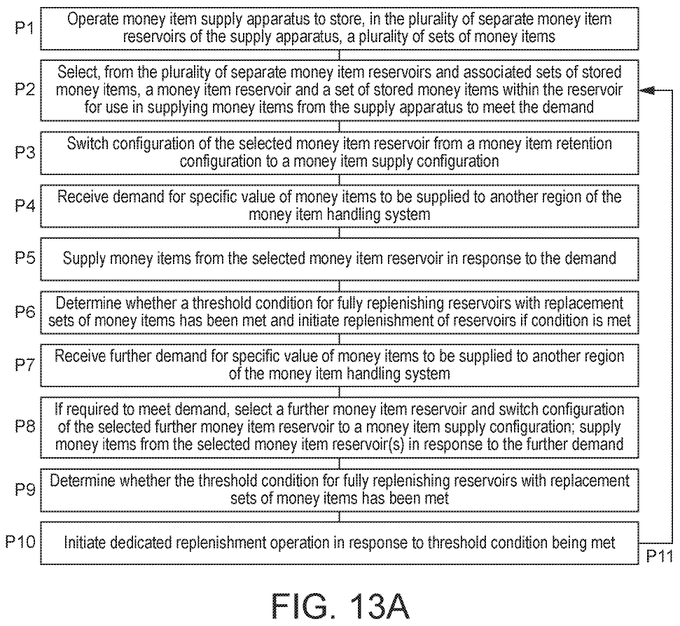

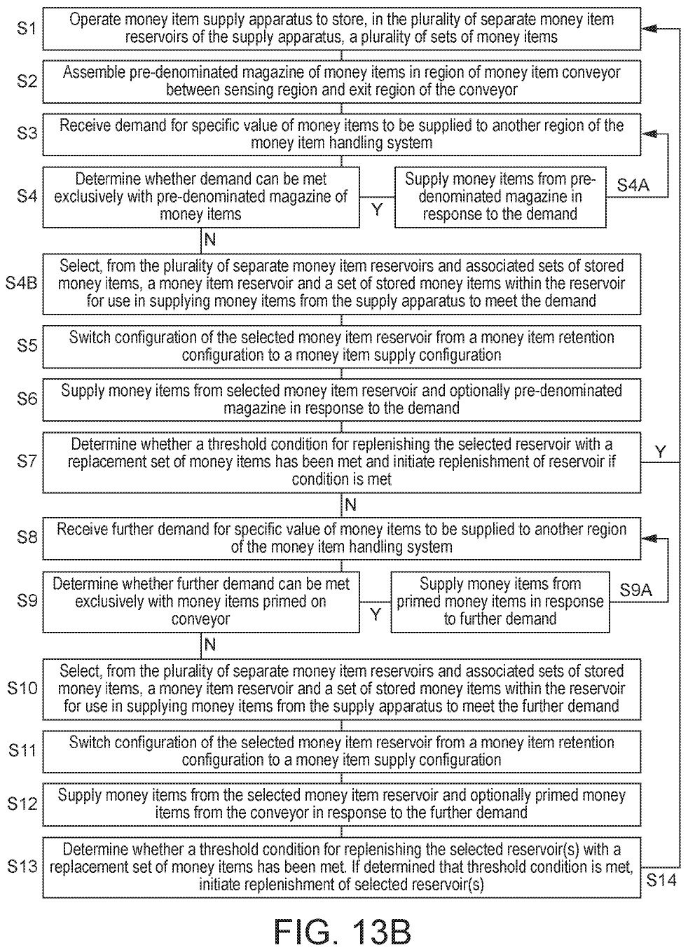

An example operation of the money item supply apparatus 100 as part of a money item handling system 1000, 2000 will now be explained with respect to FIG. 13A.

In a first stage P1 of an operational process, the money item supply apparatus 100 is operated to store, in the plurality of separate money item reservoirs 101-103 of the apparatus 100, a plurality of sets of money items. Each set of money items is stored in a different one of the plurality of separate money reservoirs 101-103 and comprises money items with a plurality of different denominations. In other words, each set of money items is a mixed denomination set of money items. The particular denominations and numbers of money item in each set are predetermined and may, for example, be currency dependent.

For example, the money item flow control apparatus 1006 of the money item handling system 1000 may be selectively operated to cause an initial plurality of money items, such as approximately 30 money items of mixed denomination, to move from the mixed denomination money item storage region of the system 1000 to the money item collection region 1002a, 2001a of the conveyor 1002, 2001 via the flow control apparatus 1006. The conveyor 1002, 2001 may be driven around its rotation path to singulate and convey individual ones of these money items to the money item sensing region 1002b, 2001b of the conveyor 1002, 2001 where the money items are each denominated and recorded (positionally) on the conveyor 1002, 2001. Further rotation of the conveyor 1002, 2001 brings the denominated money items around to the exit region 1002c, 2001c where individual money items are selectively routed into the money item input routing 200, based on their denomination, by an exit gate 1003a, 2003a of the conveyor 1002, 2001. The money items which are selectively routed into the input routing 200 correspond to money items whose denomination is needed in order to complete the predetermined sets of money items referred to above. As part of this process, the supply apparatus 100 may be continually re-orientated so as to switch different ones of the plurality of reservoirs 101-103 into (and out of) their money item receiving configurations. The timing of these re-orientations is directly related to the frequency of money items arriving at the supply apparatus 100 so as to ensure that each reservoir 101-103 is filled with its predetermined set of money items, i.e. so that individual money items which have been identified on the conveyor 1002, 2001 for filling a particular one of the reservoirs 101-103 are ultimately received in that particular reservoir 101-103, thereby contributing to the predetermined set for the reservoir 101-103, after having been routed off the conveyor 1002, 2001 at the exit gate 1003a, 2003a.

Any money items on the conveyor 1002 which are not selectively routed into one of the reservoirs 101-103 of the supply apparatus 100, for example because their denomination is not required for any of the reservoirs 101-103, may be routed at the exit region 1002c back into the mixed denomination money item storage region of the system 1000.

As money items in the receiving region 1002a, 2001a of the conveyor 1002, 2001 begin to run low in number, the money item flow control apparatus 1006 may be re-actuated to cause a further plurality of money items, such as approximately another 30 mixed denomination money items, to move into the money item collection region 1002a, 2001a. In this way, the conveyor 1002, 2001 is re-stocked with money items and the selective reservoir-filling process may continue until each of the reservoirs 101-103 has its predetermined set of mixed denomination money items. The number of money items in each set may be in the range of approximately 10-15 money items, depending on the specific implementation of the supply apparatus 100 and the currency being used. For the purposes of example, the sets may be discussed below as consisting of 11 money items, giving a total of 33 money items for a three-reservoir supply apparatus 100 such as those shown in FIGS. 1-8. Furthermore, the sets may be discussed as being the same for each reservoir 101-103. In alternative implementations, however, the sets predetermined for each reservoir 101-103 may be different to one another in denominational mix and/or total number. One example of this is for a particular one of the reservoirs 101-103 to comprise approximately double the number of money items to the other reservoirs, e.g. a double set.

During a money item filling or replenishment operation of this kind, the conveyor 1002, 2001 may be run at a reduced speed in order to reduce the frequency at which money items arrive at the exit region 1002c, 2001c of the conveyor 1002, 2001. This in turn reduces the maximum frequency with which money items can be routed off the conveyor 1002, 2001 into the input routing 200 and thereby increases the amount of available time for the supply apparatus 100 to switch between the receiving configurations of the different reservoirs 101-103 as money items are fed through the input routing 200. This ensures that the maximum frequency at which money items may be routed through the input routing 200 does not exceed the maximum frequency at which the supply apparatus 100 may be switched between the receiving configurations of different reservoirs 101-103. In other words, any particular money item arriving on the conveyor 1002, 2001 at the exit region 1002c, 2001c may be routed into any particular reservoir 101-103 of the supply apparatus 100 independently of how the preceding money item on the conveyor 1002, 2001 was routed or otherwise processed at the exit region 1002c, 2001c and/or supply apparatus 100. In some implementations, it may not be necessary for the conveyor 1002 to be run at a reduced speed in order to achieve these effects. The effects may be achieved with the conveyor 1002 running at its normal, e.g. maximum, operating speed.

While any particular one of the reservoirs 101-103 is in a money item receiving configuration and being filled with money items, the rotatable apparatus 104 may be actuated back and forth slightly (e.g. with small rotations back and forth in opposite directions), while consistently retaining alignment between the inlet 101d-103d and the input routing 200. This may assist the movement of money items into the reservoir 101-103 and help the money items to settle therein.

Once the reservoirs 101-103 are each full with a complete set of money items, any remaining money items on the conveyor 1002, 2001, may be routed back into the mixed money item storage region so that the conveyor 1002, 2001 is empty.

In a second stage P2 of the process, a money item reservoir 101 and a set of stored money items within the reservoir 101 are selected, from the plurality of separate money item reservoirs 101-103 and associated sets of stored money items, for use in supplying money items from the supply apparatus 100 to meet a future demand. As discussed above, certain ones of the reservoirs 101-103 may be more preferred than others for supply operations. In a situation where all reservoirs 101-103 are full with complete money item sets, the first reservoir 101, which is the default most preferred money item reservoir 101, is the one selected.

In a third stage P3 of the process, the configuration of the selected money item reservoir 101 is switched from a money item retention configuration (such as the money item receiving configuration or any other retention configuration of the reservoir 101) to a money item supply configuration. For example, the rotatable apparatus 104 may be rotated to an orientation in which the money item outlet 101e of the reservoir 101 is aligned with an open end of the money item output routing 300 discussed above. This may cause the complete set of money items in the selected reservoir 101 to slide out of the reservoir 101, under gravity, into the output routing 300.

Referring to FIG. 10, the output routing 300 may direct the money items emptied from the reservoir 101 to the receiving region 1002a, 2001a of the conveyor 1002, 2001. As part of this stage P3 of the process, the conveyor 1002, 2001 may be rotated around its looped path so that the money items are conveyed by the conveyor 1002, 2001 to a location which is close to the exit region 1002c, 2001c. During this aspect of the process, once past the sensing region 1002b, the denomination of each money item on the conveyor 1002, 2001 may be tracked as part of a denominated magazine of money items between the sensing region 1002b, 2001b and the exit region 1002c, 2001c. The denominated magazine primes the conveyor 1002, 2001 with a known set of mixed money items, in a known order, ready to be used to meet a future demand for money items.

In a fourth stage P4 of the process, a demand is received for a specific value of money items to be supplied to another region of the money item handling system 1000. An example of such a demand is for a specific value of money items to be dispensed to a user of the system 1000 as part of a transaction, e.g. via an outlet cup or other externally accessible collection region of the system 1000.

In a fifth stage P5 of the process, money items from the previously selected reservoir 101 are supplied to meet the demand for money items elsewhere in the system 1000. As outlined above, the set of money items from the reservoir 101 are already primed on the conveyor 1002, 2001 and so, by moving the conveyor, the set of money items immediately enters the exit region 1002c, 2001c of the conveyor 1002, 2001. In the exit region 1002c, 2001c, required ones of the set of money items from the reservoir 101 can be routed off the conveyor 1002, 2001 via an appropriate exit gate 1003b-c, 2003a-c in order to meet the demand.

For example, an exit gate 1003b in the exit region 1002c may be selectively opened in order to route money items making up the specific value specified in the demand to an outlet cup of the system 1000. As explained previously, the predetermined set of money items emptied out of the selected reservoir 101 may be capable of making up any monetary value to a certain maximum, such as the total value of the set. Money items from the reservoir 101 which are not ultimately used to meet the demand may remain on the conveyor 1002, 2001 for use in meeting a future demand for money items.

If the value of money items required to meet the demand is greater than the maximum value of the first set of money items primed on the conveyor 1002, 2001, the supply apparatus 100 may be used to supply further money items. In particular, a further (e.g. the next preferred) money item reservoir 102 and set of stored money items within the reservoir 102 may be selected, from the plurality of remaining money item reservoirs 102-103 and associated sets of stored money items, to be emptied into the receiving region 1002a, 2001a of the conveyor 1002, 2001. The further set of money items is then conveyed by the conveyor 1002, 2001 to the exit region 1002c, 2001c, where money items are selectively routed off the conveyor 1002, 2001, as needed, in order to fulfil any demand which cannot be met by money items from the first set.

Any remaining money items on the conveyor 1002, 2001 following fulfilment of the demand may be retained on the conveyor 1002, 2001 for use in meeting a future demand for money items. In other words, the conveyor 1002, 2001 is re-primed with a known set of money items in the manner previously described. Optimally, the re-primed set of money items is a full set corresponding to the predetermined sets initially loaded in the reservoirs of the supply apparatus 100. If the conveyor 1002, 2001 contains money items which are surplus to the full set required for priming the magazine, the surplus items may be routed back into the supply apparatus 100. For example, the surplus money items may be routed back into the first reservoir 101 in order to partially refill the first reservoir 101.

In a sixth stage P6 of the process, the system 1000 is configured to determine whether a threshold condition for fully replenishing the reservoir(s) 101, 102 so as to again contain complete set(s) of money items has been met. The threshold condition may be related to the status of the reservoirs in the apparatus 100. For example, the threshold condition may be related to whether or not any of the reservoirs 101-103 of the supply apparatus 100 is currently loaded with a full set of money items. If one or more such full sets are available in the supply apparatus 100, it may be determined by the system 1000 that the threshold condition for initiating a dedicated operation to fully replenishing the empty and/or partially empty reservoirs 101, 102 has not been met.

In a seventh stage P7 of the process, a further demand is received for a specific value of money items to be supplied to another region of the money item handling system 1000. This is a repetition of the fourth stage P4.

In an eighth stage P8 of the process, money items from the primed set of money items on the conveyor 1002, 2001 are routed off the conveyor 1002, 2001 in order to fulfil the further demand in the manner previously described.

If the further demand cannot be met exclusively with money items already present on the conveyor 1002, 2001, the supply apparatus 100 may be used to supply further money items. In particular, the next preferred money item reservoir 103 still containing a full set of money items may be selected and emptied into the receiving region 1002a, 2001a of the conveyor 1002, 2001. The new set of money items is then conveyed by the conveyor 1002, 2001 to the exit region 1002c, 2001c, in the manner previously described with respect to the fifth stage P5, where money items are selectively routed off the conveyor 1002, 2001, as needed, in order to fulfil any demand which cannot be met by the money items already present on the conveyor 1002, 2001.

As before, any remaining money items on the conveyor 1002, 2001 following fulfilment of the demand may be retained on the conveyor 1002, 2001 for use in meeting a future demand for money items. If there are surplus money items, for example duplicate money items not required for a full set of money items on the conveyor 1002, 2001, these may be routed back into the supply apparatus 100—for example in order to further refill the first reservoir 101 or begin refilling the second reservoir 102.

In a ninth stage P9 of the process, the system 1000 is configured to repeat the sixth stage P6 by determining whether a threshold condition for fully replenishing the reservoir(s) 101, 102, 103, so as to again contain complete set(s) of money items, has been met. The factors which are taken into account in determining whether the threshold replenishment condition has been met may include not only the likelihood of whether the supply apparatus 100 may shortly run out of money items but also environmental factors such as the frequency at which new demands for money items are generally received in the particular setting of the system 1000. Another factor taken into account may be whether the system 1000 currently has a full set of money items on the conveyor 1002. If such a full set of money items is present, the risk of not being able to rapidly fulfil a new demand for money items is reduced.

It should be further appreciated that, in determining when to replenish emptied reservoirs 101, 102 of the supply apparatus 100 with new sets of money items, the system 1000 seeks not only to avoid running short of rapidly suppliable pre-denominated money items but also seeks to avoid over-processing and corresponding inefficiencies in the operation of the conveyor 1002, flow control apparatus 1006, gates 1003a-c, supply apparatus actuator(s) and other associated parts of the system 1000.

When the threshold condition is met, a dedicated money item replenishment operation is performed as a tenth stage P10 of the process. The replenishment operation corresponds closely with the filling operation described above with respect to the first stage P1. The difference between the two processes may be that, whereas the first stage P1 begins with all reservoirs 101-103 fully empty, the tenth stage P10 may begin with one or more of the reservoirs partially or even fully loaded with a set of money items. As such, the tenth stage P10 may take less time than the first stage P1.

In the event that a new demand for money items is received while the dedicated replenishment operation is ongoing and incomplete, the conveyor 1002, 2001 may be run at full speed to pass money items through the sensing region 1002b, 2001b and exit region 1002c, 2001c. This allows selective routing of money items off the conveyor 1002, 2001 in order to meet the demand. As part of this process, known money items in one or more reservoirs 101, 102 may be emptied onto the conveyor 1002, 2001 in order to assist in rapidly fulfilling the demand. Once the demand is met, the replenishment operation resumes.

In an eleventh stage P11, the process returns to the second stage P2 described above. If the threshold condition has not yet been met and therefore the tenth stage P10 has not yet been performed, the process returns instead to the seventh stage P7.

A further example operation of the money item supply apparatus 100 as part of a money item handling system 1000, 2000 will now be explained with respect to FIG. 13B.

In a first stage S1 of an operational process, the money item supply apparatus 100 is operated to store, in the plurality of separate money item reservoirs 101-103 of the apparatus 100, a plurality of sets of money items. The first stage S1 corresponds to the first stage P1 of the process described above and so its explanation will not be repeated here.

In a second stage S2 of the process, the conveyor 1002 may be rotated to create a pre-denominated magazine of money items in the region of the conveyor 1002 between the sensing region 1002b and the exit region 1002c. The denominated magazine of money items preferably comprises a plurality of money items of mixed denomination, which can be rapidly routed off the conveyor 1002, as required, in order to help meet the next demand for money items. The system 1000 may be configured to actively build the magazine with a specific predetermined mix of money items from the mixed storage region of the system 1000, in a manner similar to the selective assembly of the sets of money items in the supply apparatus 1002 (P1 and S1).

For example, using the money item flow control apparatus 1006 in the manner previously described, the system 1000 may feed groups of money items into the receiving region 1002a of the conveyor 1002 from the mixed denomination storage region of the system 1000. The conveyor 1002, 2001 may be driven around its rotation path to singulate and convey individual ones of these money items to the money item sensing region 1002b, 2001b of the conveyor 1002, 2001 where the money items are each denominated and recorded (positionally) on the conveyor 1002, 2001. Further rotation of the conveyor 1002, 2001 brings the denominated money items around to the exit region 1002c, 2001c. At the exit region 1002c, 2001c, the system 1000 may cause money items which are not desirable for the magazine, for example because they do not correspond to the desired mix of money items for magazine, to be routed off the conveyor 1002 into the mixed storage region. Money items which are desirable, on the other hand, are retained in the conveyor 1002, 2001a. Further money items may be fed onto the conveyor 1002, 2001 by the flow control apparatus 1006, and the conveyor 1002, 2001 further rotated, until the money item magazine has been assembled.

Following completion of the second stage S2, the system 1000 is primed with a pre-denominated magazine of money items on the conveyor 1002, 2001 close the exit region 1002c, 2001c. This magazine is in addition to having full sets of money items in each of the plurality of reservoirs 101-103 in the supply apparatus 100. Aside from the money items selected for the magazine, the conveyor 1002, 2001 is empty of money items.

In a third stage S3 of the process, a demand is received for a specific value of money items to be supplied to another region of the money item handling system 1000. An example of such a demand is for a specific value of money items to be dispensed to a user of the system 1000 as part of a transaction, e.g. via an outlet cup or other externally accessible collection region of the system 1000.

In a fourth stage S4 of the process, the system 100 initially determines whether the demand can be met using money items exclusively from the pre-denominated magazine on the conveyor 1002, 2001. If the demand can be met in this way, the system 1000 proceeds, in a further stage S4A, by routing money items in the magazine off the conveyor 1002, 2001, via an appropriate exit gate 1003b-c, in order to fulfil the demand. For example, an exit gate 1003b in the exit region 1002c may be selectively opened in order to route money items making up the specific value specified in the demand to an outlet cup of the system 1000.

However, if the demand cannot be met exclusively with money items from the magazine, the system 1000 proceeds in an alternative stage S4B, to select a money item reservoir 101 from the supply apparatus 100. In this stage S4B of the process, a money item reservoir 101 and a set of stored money items within the reservoir 101 are selected, from the plurality of separate money item reservoirs 101-103 and associated sets of stored money items, for use in supplying money items from the supply apparatus 100 to meet the demand. As discussed above, certain ones of the reservoirs 101-103 may be more preferred than others for supply operations. In a situation where all reservoirs 101-103 are full with complete money item sets, the first reservoir 101, which is the default most preferred money item reservoir 101, may be the one selected.

In a fifth stage S5 of the process, the configuration of the selected money item reservoir 101 is switched from a money item retention configuration (such as the money item receiving configuration or any other retention configuration of the reservoir 101) to a money item supply configuration. For example, the rotatable apparatus 104 may be rotated to an orientation in which the money item outlet 101e of the reservoir 101 is aligned with an open end of the money item output routing 300 discussed above.

In a sixth stage S6 of the process, money items in the selected reservoir 101 are supplied to meet the demand for money items elsewhere in the system 1000. For example, the complete set of money items in the selected reservoir 101 may slide out of the reservoir 101, under gravity, into the output routing 300. In one example, referring to FIG. 10, the output routing 300 may direct the money items to the receiving region 1002a of the conveyor 1002 so that the money items are conveyed by the conveyor 1002 back to the exit region 1002c via the sensing region 1002b. Once past the sensing region 1002b, the denomination of each money item may be tracked as part of a denominated magazine of money items between the sensing region 1002b and the exit region 1002c so that, at the exit region 1002c, required ones of the predetermined mixed set of money items from the reservoir 101 can be routed off the conveyor 1002 via an appropriate exit gate 1003b-c in order to meet the demand.

For example, an exit gate 1003b in the exit region 1002c may be selectively opened in order to route money items making up the specific value specified in the demand to an outlet cup of the system 1000. As explained previously, the predetermined set of money items emptied out of the selected reservoir 101 may be capable of making up any monetary value to a certain maximum, such as the total value of the set. However, optionally, the demand may be met with a combination of money items from the pre-denominated magazine and the selected money item reservoir 101, rather than exclusively with money items from the selected reservoir 101.

Money items from the reservoir 101 and/or magazine which are not ultimately used to meet the demand, i.e. after stages S4A or S6, may remain on the conveyor 1002 and primed ready to meet the next demand for money items. Alternatively, at least in the case of money items from the reservoir 101, such money items may be routed back into the reservoir 101 from which they were dispensed. In this way, the emptied reservoir 101 may be partially replenished with some of the money items from the set. Alternatively, the money items may be routed off the conveyor 1002 into another part of the system 1000, such as the mixed storage region or a separate external cashbox outside of the system 1000.

In a seventh stage S7 of the process, the system 1000 is configured to determine whether a threshold condition for fully replenishing the first reservoir 101 so as to again contain a complete set of money items has been met. The threshold condition may be related to the status of the other reservoirs in the apparatus 100. For example, the threshold condition may be related to whether or not the other reservoirs 101-103 of the supply apparatus 100, which in this example comprise the second and third reservoirs 102, 103, are currently loaded with full sets of money items. If one or more such full sets are available in the other reservoirs 102, 103 of the supply apparatus 100, then it may be determined by the system 1000 that the threshold condition for fully replenishing the first (emptied) reservoir 101 has not yet been met.

Additionally or alternatively, the threshold condition may be related to the status of the first reservoir 101 itself. For example, if the first reservoir 101 has already been partially replenished with a predetermined number and/or value of money items from the original set, it may be determined that the threshold condition has not yet been met and that the system should await the next demand for money items before considering further replenishment operations.

In an eighth stage S8 of the process, a further demand is received for a specific value of money items to be supplied to another region of the money item handling system 1000, such as the outlet cup mentioned above.

In a ninth stage S9 of the process, if there are money items primed on the conveyor 1002, 2001 from the earlier stages S4A/S6, it is determined whether the further demand can be met exclusively with money items from the primed set of money items. If this is the case, in a further stage S9A, money items from the conveyor are routed off the conveyor 1002, 2001 in order to fulfil the further demand in the manner previously described.

If the further demand cannot be met exclusively with money items already present on the conveyor 1002, 2001, the supply apparatus 100 may, in an alternative further stages S10-S12, be used to supply further money items. In particular, the next preferred money item reservoir 102 still containing a full set of money items may be selected and emptied into the receiving region 1002a, 2001a of the conveyor 1002, 2001. The new set of money items is then conveyed by the conveyor 1002, 2001 to the exit region 1002c, 2001c, in the manner previously described with respect to the sixth stage S6, where money items are selectively routed off the conveyor 1002, 2001, as needed, in order to fulfil any demand which cannot be met by money items already present on the conveyor 1002, 2001.

In a thirteenth stage S13 of the process, the system 1000 is configured to again determine whether a threshold condition for replenishing the emptied reservoirs 101, 102 with new sets of money items from the conveyor 1002 has been met. In this instance, the system 1000 may determine that the condition has been met because there is only one full set of money items remaining in the supply apparatus 100, i.e. the set in the third (least preferred) reservoir 103.

As discuss above, the factors which are taken into account in determining whether the threshold replenishment condition has been met may include environmental factors such as the frequency at which new demands for money items are generally received in the particular setting of the system 1000. Another factor may be whether the system 1000 currently has a preferred magazine of money items in the region of the conveyor 1002 between the sensing region 1002b and the exit region 1002c. If such a magazine has been successfully assembled, the risk of not being able to rapidly fulfil a new demand for money items is reduced because the magazine compensates for the loss of money item sets in the supply apparatus 1000.

In a fourteenth stage S14 of the process, the system 1000 initiates a money item replenishment operation to fill the emptied first and second reservoirs 101, 102 with new sets of money items. This replenishment operation corresponds closely with the filling operation mentioned above with respect to the first stage S1. Of course, as the third reservoir 103 is already full with a complete money item set, the inlet 103d of the third reservoir 103 remains unaligned with the money item input routing 200 while the first and second reservoirs 101, 102 are moved into and out of their money item receiving configurations to refill them with selected money items routed off the conveyor at the exit gate 1003a.

It should be appreciated that the supply apparatus 100 described above has the capacity to significantly reduce, or altogether eliminate, the need to carry out active hunting operations following the receipt of a demand for money items. The supply apparatus 100 achieves this whilst still permitting the vast majority of money items to be stored in a large mixed denomination storage region of the money item handling system 1000. This is highly advantageous and desirable, as active hunting operations not only introduce delays to the supply of required money items but are also generally inefficient in their use of power and cause wear on equipment. The supply apparatus 100 improves the efficiency of the overall system by reducing delays, improving system reliability and reducing the complexity of components.

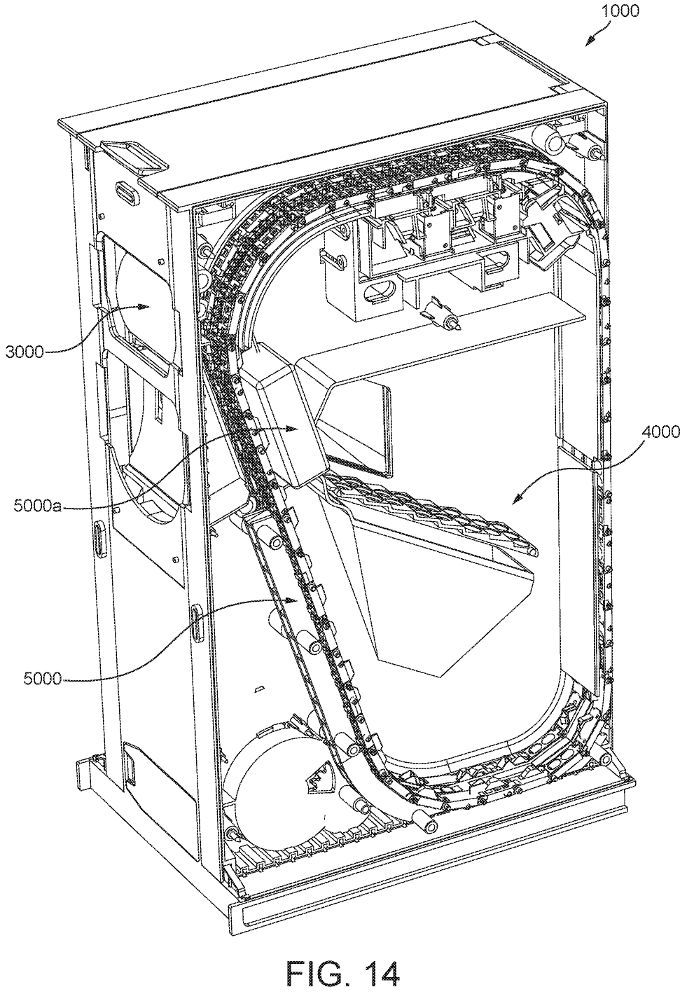

FIG. 14 illustrates a cut-away view of one side of the money item handling system 1000. As can be seen from this figure, the system 1000 comprises a money item entry gate apparatus 3000 through which money items can be fed into the system 1000 from an exterior of the system housing. Money items which are successfully fed through the gate apparatus 3000 enter the internal region of the system 1000 and are directed, for example via a debris filter 4000, to a pay-in module or other money item receiving apparatus of the money item handling apparatus 1000. This money item receiving apparatus may, for example, comprise a money item conveyor 5000 which is configured to collect money items received at the conveyor 5000 from the gate apparatus 3000 and convey the money item past a money item validation region 500oa of the conveyor 5000, comprising one or more validators, in order to determine the acceptability of the money items to the system 1000. Money items which are determined to be acceptable at the receiving apparatus may be routed, for example, to the mixed denomination storage region or money item receiving region 1002a, 2001a of the separate conveyor 1002, 2001 discussed above. Money items which are determined to be unacceptable, on the other hand, may be routed directly back to the exterior of the housing (e.g. to a collection cup).

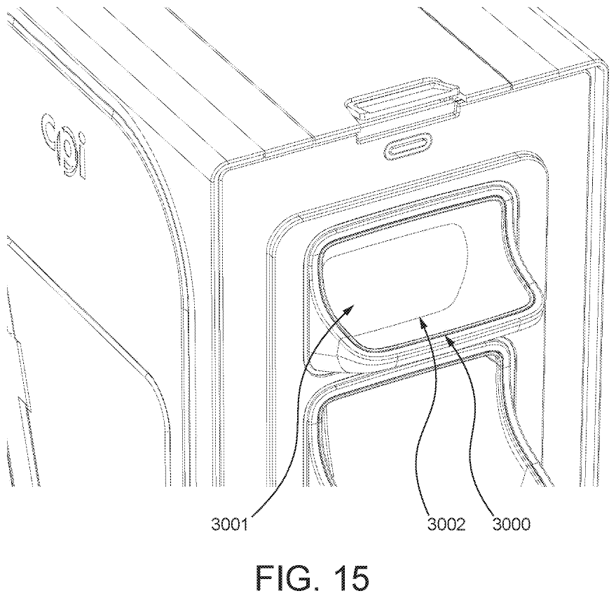

As will now be explained, the money item gate apparatus 3000 is configured to perform a plurality of different functions, depending on its selected mode of operation. A first operation mode of the entry gate apparatus 3000 is shown in FIG. 15. As can be seen from this figure, the gate apparatus 3000 comprises a flow restriction element 3001 which is operable to selectively block or unblock any entry aperture 3002 of the apparatus 3000. In the operational mode illustrated in FIG. 15, the flow restriction element 3001 is actuated to a fully closed position so that money items are completely blocked from entering the gate apparatus 3000 and thus the interior region of the money item handling system 1000.

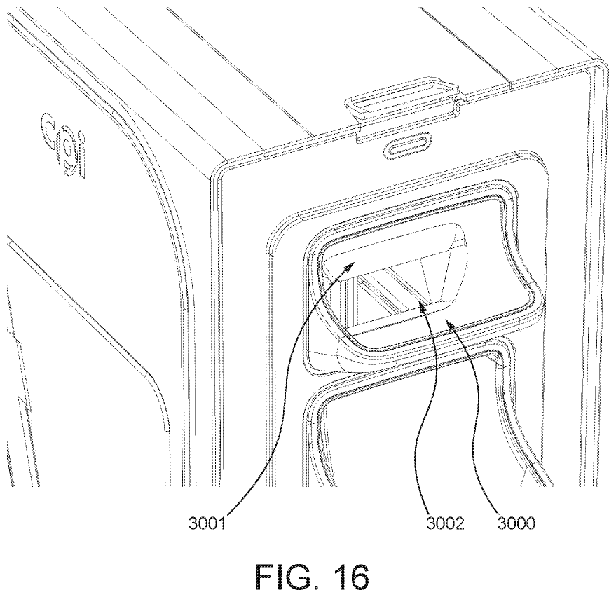

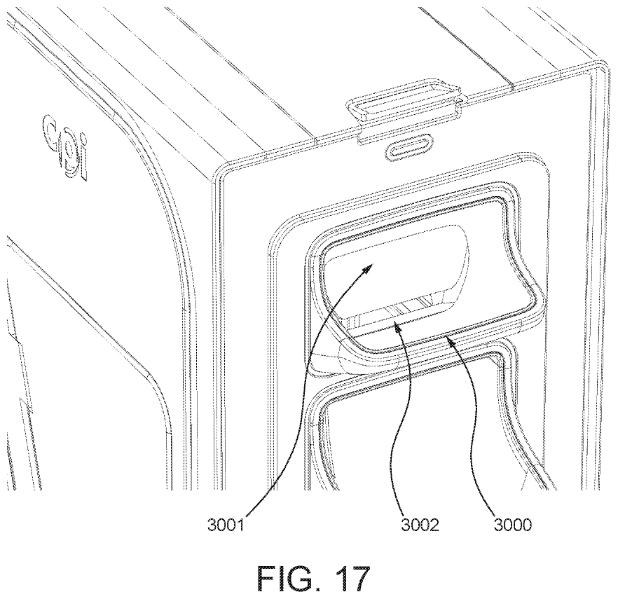

FIG. 16 illustrates a second operation mode of the gate apparatus 3000. In this figure, the flow restriction element 3001 is actuated to a fully open position so that the maximum flow rate of money items through the gate apparatus is restricted only by the size and shape of the entry aperture 3002. FIG. 17 illustrates a third operation mode of the gate apparatus 3000. In this figure, the flow restriction element 3001 is actuated to a partially open position so that the maximum flow rate of money items through the gate apparatus 3000 is significantly restricted relative to the second operation mode shown in FIG. 16. In the third mode, for example, the position of the flow restriction element 3001 may be such that money items may enter the gate apparatus 3000 only one-by-one.

These different operational modes of the gate apparatus 3000 provide significant functional flexibility and advantages for the system 1000. For example, in normal operation, the gate apparatus 3000 may be operated in the third mode of FIG. 17 so as to ensure that large items of debris or other non-money items cannot pass into the system 1000 via the gate apparatus 3000. However, in order to permit a rapid bulk fill operation by a trusted person, such as service person, the gate apparatus 3000 may operate in the second mode of FIG. 16 so as to allow large quantities of money items to be emptied into the system 1000 via the gate apparatus 3000 in a short amount of time. This is beneficial for the security of the system 1000 and the person involved in performing the bulk fill operation. The first operation mode of gate apparatus 3000 is used when it is temporarily desirable for no new money items to be entered into the system 1000. For example, in a situation where the system is out of use or powered down, it is desirable to prevent potential users from mistakenly entering new money items into the system 1000 as part of an attempted transaction. Other situations where it may be advantageous to prevent users from entering new money items into the system 1000 include where the user has already entered a sufficient value of money items to complete a transaction, or where the system 1000 is carrying out internal operations in between transactions and is not yet ready for a new transaction to be initiated.

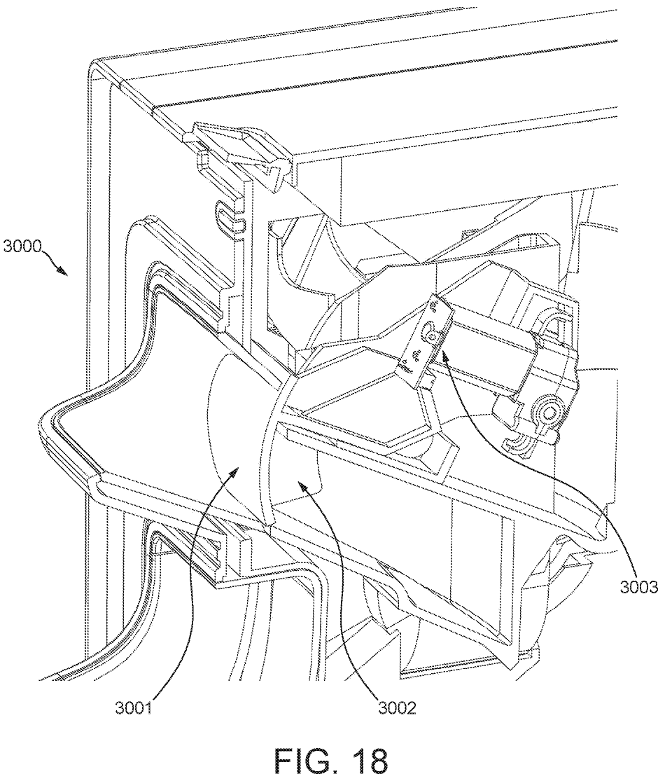

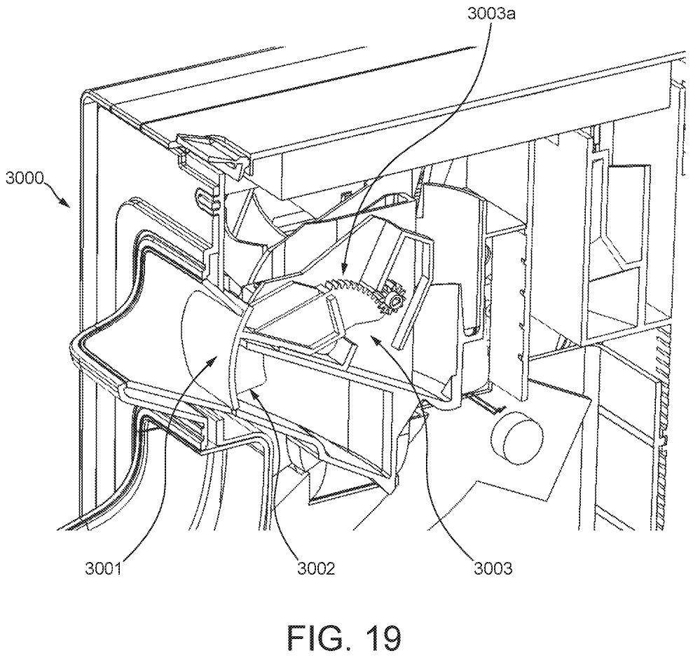

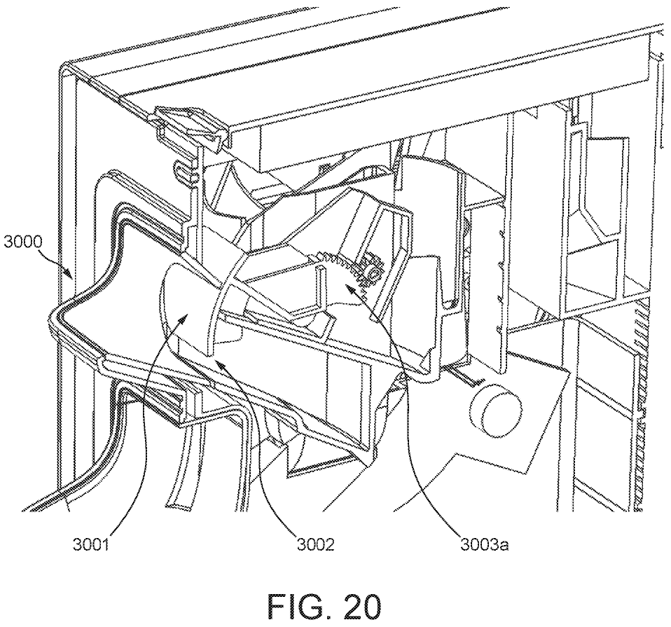

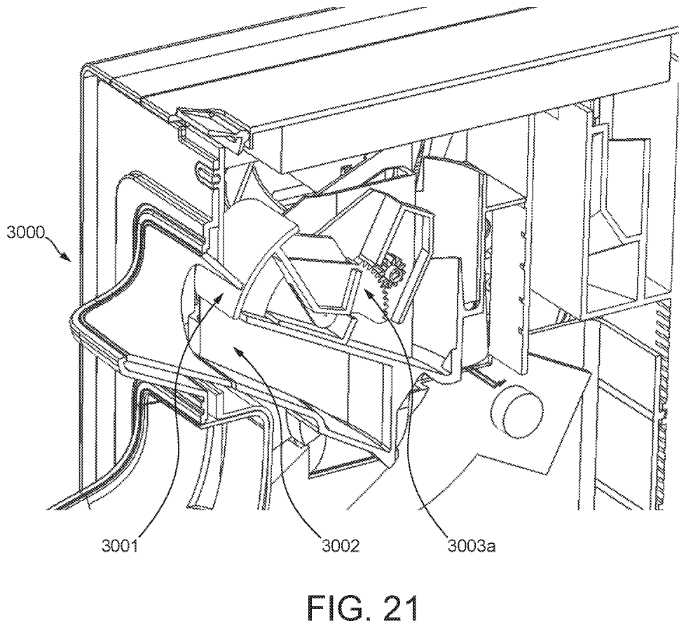

FIGS. 18-21 show further views of the gate apparatus 3000 and its various components. Referring to FIG. 18, the gate apparatus 3000 comprises a motor-driven actuator 3003 which is configured to control the position of the flow restriction element 3001 relative to the entry aperture 3002. FIG. 19 shows a further cut-away of the view given in FIG. 18, in which gearing 3003a of the actuator 3003 can be seen. In FIGS. 18 and 19, the flow restriction element 3001 is actuated so as to fully block the entry aperture 3002. This corresponds to the first mode of the apparatus 3000 described above. However, in FIG. 20, in which the gearing 3003a of the actuator 3003 can again be seen, the flow restriction element 3001 has been actuated so as to only partially block the entry aperture 3002. This corresponds to the third mode of the apparatus 3000. In FIG. 21, the flow restriction element 3001 has been further actuated to fully open the entry aperture 3002. This corresponds to the second mode of the apparatus 3000.

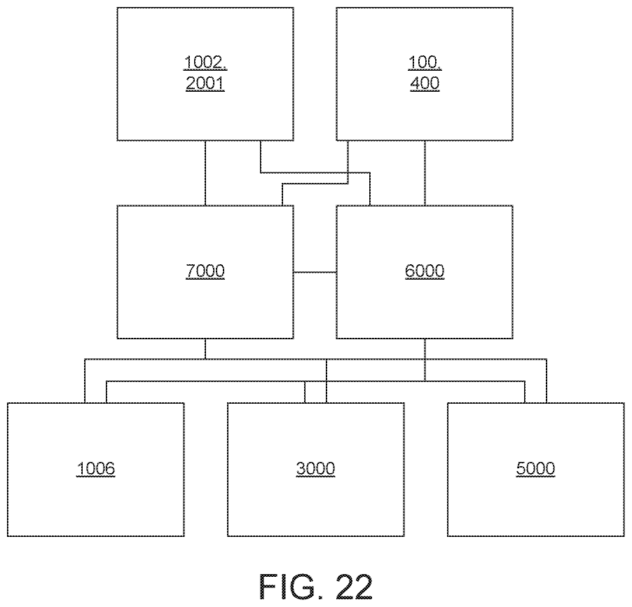

Referring to FIG. 22, operation of the system 1000, 2000 including the money item supply apparatus 100, 400 entry gate apparatus 3000 and other powered parts of the system, may be controlled by a computing apparatus 6000. For example, the computing apparatus 6000 may selectively control actuation of the supply apparatus 100, 400 between the different reservoir configurations described above by causing appropriate control signals to be supplied to the actuator of the supply apparatus 100, 400. The computing apparatus may also selectively control actuation of the gate apparatus 3000 between the different operational modes shown in FIGS. 15-21, as well as movement of the conveyors 1002, 2001, 5000 and actuation of the flow control apparatus 1006, using appropriate control signals. The computing apparatus may also control other aspects of the money item handling system 1000, such as the outlet gates 1003a-c, 2003a-c at the conveyor 1002, 2001, using further appropriate control signals. In particular, the computing apparatus may cause actuators of the outlet gates 1003a-c, 2003a-c to selectively actuate the gates 1003a-c, 2003a-c to open positions when money items are to be diverted off the conveyor 1002, 2001. The actuators will then return the gates 1003a-c, 2003a-c to a closed position.

The computing apparatus 6000 may be communicatively coupled to a power supply 7000 of the system 1000. The power supply 7000 facilitates movement and control of the system parts discussed above, as required and instructed by the computing apparatus 6000.

The computing apparatus 6000 comprises at least one computer processor and at least one computer memory. The processor executes computer-readable instructions stored in the memory to cause the movement and functional control of the system 1000, including that of the elements specifically mentioned above. For the avoidance of doubt, the computing apparatus may include a single processor or may comprise one or more architectures employing multiple processor designs for increased computing capability. The computer memory may comprise, for example, one or more read-only memories (ROMs), random access memories (RAMs), EPROMs, EEPROMs, Flash memories, magnetic or optical cards or application specific integrated circuits (ASICs). Additionally or alternatively, the computer memory may comprise any type of storage disk, such as one or more floppy disks, optical disks, CD-ROMs and/or magnetic-optical disks, or any other type of media suitable for storing electronic instructions which can be executed by the processor. The memory is coupled to the processor and other elements of the computing apparatus architecture via a computer system bus. The processor is configured to implement the instructions under the control of the computer-readable instructions to operate the system 1000.

As previously explained, money items which are collected by the conveyor 1002, 2001 are denominated in the money item sensing region 1002b, 2001b of the conveyor 1002, 2001 so that, once a money item on the conveyor 2000 has passed the sensing region 1002b, 2001b at least once, its denomination and position on the conveyor 1002, 2001 is known to the system 1000. Once money items have passed the sensing region 1002b, 2001b, the denomination and position of each money item on the conveyor 1002, 2001 may, for example, be stored in a memory of the system 1000 to create the magazine referred to above.

It will be appreciated that there are various modifications and adaptations that can be made to the specific aspects of the system 1000 described above. In particular, although the money item supply apparatus 100, 400 has been principally described in the context of a rotatable apparatus 104, 404 comprising the plurality of reservoirs 101-103, 401-403, the supply apparatus 100, 400 and reservoirs 101-103, 401-403 may alternatively be provided in a different form.

The aspects described above may be used either singly or in combination. In this specification, the term “money items” refers, for example, to coins or other tokens of a monetary value.

1. A money item supply apparatus, comprising:
a plurality of separate money item reservoirs configured to store a plurality of sets of money items of mixed denomination, wherein each of the plurality of separate money item reservoirs is configured to store a different one of the plurality of sets of money items,
wherein each of the plurality of separate money item reservoirs is selectively switchable between a plurality of operating configurations comprising at least a money item retention configuration and a money item supply configuration.

2. The money item supply apparatus of claim 1, wherein, for each of the plurality of separate money item reservoirs, switching to the money item supply configuration from another of the plurality of operating configurations comprises aligning a money item outlet of the money item reservoir with a money item output routing.

3. The money item supply apparatus of claim 1, wherein, for each of the plurality of separate money item reservoirs, switching from the money item supply configuration to another of the plurality of operating configurations comprises unaligning a money item outlet of the money item reservoir with a money item output routing.

4. The money item supply apparatus of claim 1, wherein the plurality of operating configurations further comprises at least a money item receiving configuration.

5. The money item supply apparatus of claim 4, wherein for each of the plurality of separate money item reservoirs, switching to the money item receiving configuration from another of the plurality of operating configurations comprises aligning a money item inlet of the money item reservoir with a money item input routing.

6. The money item supply apparatus of claim 4, wherein, for each of the plurality of separate money item reservoirs, switching from the money item receiving configuration to another of the plurality of operating configurations comprises unaligning a money item inlet of the money item reservoir with a money item input routing.

7. The money item supply apparatus of claim 4, wherein the money item receiving configuration is a sub configuration of the money item retention configuration.

8. The money item supply apparatus of claim 5, comprising a rotatable apparatus, wherein the plurality of separate money item reservoirs is located in the rotatable apparatus.

9. The money item supply apparatus of claim 8, wherein separate reservoirs of the plurality of separate money item reservoirs are separated from one another by at least one internal dividing wall of the rotatable apparatus.

10. (canceled)

11. (canceled)

12. The money item supply apparatus of claim 8, wherein the money item inlets of the plurality of separate money item reservoirs are located adjacent to one another in an inlet region of the rotatable apparatus.

13. The money item supply apparatus of claim 12, wherein the money item inlets of the plurality of separate money item reservoirs are located in a row which is uninterrupted by money item outlets.

14. The money item supply apparatus of claim 8, wherein the money item inlet of at least one of the plurality of money item reservoirs is located on an opposite side of the rotatable apparatus to the at least one of the plurality of money item reservoirs.

15. The money item supply apparatus of claim 14, wherein the money item inlet of at least one money item reservoir comprises a channel which extends through a central region of the rotatable apparatus to the at least one money item reservoir.

16. The money item supply apparatus of claim 8, wherein the rotatable apparatus is configured to rotate on an axis and wherein, for each of the plurality of separate money item reservoirs, switching from any particular one of the plurality of operating configurations to any particular other one of the plurality of operating configurations comprises the rotatable apparatus rotating from a first position to a second position.

17. The money item supply apparatus of claim 8, wherein, for each of the plurality of separate money item reservoirs, each of the plurality of operating configurations corresponds to a different rotational position of the rotatable apparatus.

18. (canceled)

19. The money item supply apparatus of claim 16, further comprising an actuator configured to selectively rotate the rotatable apparatus between different rotational positions.

20. The money item supply apparatus of claim 8, wherein the money item input routing is located at a first position relative to the rotatable apparatus and a money item output routing is located a second, different position relative to the rotatable apparatus.

21. The money item supply apparatus of claim 20, wherein the money item input routing is configured to feed money items towards the rotatable apparatus from a first direction and wherein the money item output routing is configured to receive money items from the rotatable apparatus from a second direction.

22-29. (canceled)

30. A method of operating a money item supply apparatus, comprising:
storing, in a plurality of separate money item reservoirs of the money item supply apparatus, a plurality of sets of money items, wherein each set of money items is stored in a different one of the plurality of separate money reservoirs and comprises money items of mixed denominations;
selecting, from the plurality of separate money item reservoirs and sets of stored money items, a money item reservoir and a set of stored money items;
switching an operating configuration of the selected money item reservoir from a first operating configuration to a second operating configuration, wherein the second operating configuration is a money item supply configuration; and
supplying, from the selected money item reservoir in the money item supply configuration, the selected set of stored money items.

31-45. (canceled)

46. A method of operating a money item supply apparatus, comprising:
determining to fill at least two of a plurality of separate money item reservoirs of the money item supply apparatus with sets of money items, wherein each set of money items is to be stored in a different one of the at least two separate money item reservoirs and comprises money items of mixed denominations;
selecting, from the at least two separate money item reservoirs, a first money item reservoir for receipt of one or more first money items of a first set;
switching a configuration of the selected first money item reservoir to a money item receiving configuration;
routing the one or more first money items into the selected first money item reservoir while in the money item receiving configuration;
selecting, from the at least two separate money item reservoirs, a second money item reservoir for receipt of one or more second money items of a second set;
switching a configuration of the selected second money item reservoir to a money item receiving configuration; and
routing the one or more second money items into the selected second money item reservoir while in the money item receiving configuration.

47-59. (canceled)
